(19) United States
(12) Patent Application Publication
(10) Pub. No.: US 2025/0259102 A1
(43) Pub. Date: Aug. 14, 2025

(54) DYNAMIC GENERATION AND APPLICATION OF PARAMETER UPDATE DATA IN DISTRIBUTED MACHINE LEARNING

(71) Applicant: Telefonaktiebolaget LM Ericsson (publ), Stockholm (SE)

(72) Inventors: Jinrong WANG, Ottawa (CA); Ben LIANG, Whitby (CA); FAPI THEPIE, Cote-Saint-Luc (CA); Zhongwen ZHU, Saint-Laurent (CA); Hardik DALAL, Montreal (CA)

(73) Assignee: Telefonaktiebolaget LM Ericsson (publ), Stockholm (SE)

(21) Appl. No.: 18/992,573

(22) PCT Filed: Jul. 19, 2023
(86) PCT No.: PCT/IB2023/057370

§ 371 Date: Jan. 9, 2025

Related U.S. Application Data
(60) Provisional application No. 63/391,397, filed on Jul. 22, 2022.

(51) Int. Cl. G06N 20/00

(52) U.S. Cl. CPC G06N 20/00

(57) ABSTRACT

Methods, systems and computer program products for distributed machine learning are provided. Such methods, systems and products may comprise, or may comprise instructions operable to configure one or more processors to perform, a set of acts. Such acts may comprise a plurality of nodes performing a set of training round activities, and a server performing a set of network topology design activities. The network topology design activities may comprise the server generating update data based on data from the plurality of nodes. The plurality of nodes may use that data to update control values used to exchange and combine machine learning models. After the set of training round activities and the set of network topology design activities have been repeated one or more times, the plurality of nodes may send machine learning models to the server, and the server may use them to create an aggregated machine learning model.

### TECHNICAL FIELD

The present disclosure generally relates to the field of distributed machine learning. More particularly, and not by way of any limitation, the present disclosure is directed to dynamically modifying relationships between nodes in a distributed machine learning environment.

### BACKGROUND

Large scale machine learning often requires distributed storage and computing. Most well-known distributed machine learning algorithms and systems are built in a centralized fashion (e.g., with a dedicated parameter server). Distributed machine learning, such as exemplified by device to device networks is an alternative to centralized large scale machine learning systems. In a distributed machine learning system, a machine learning model can be created through the combined efforts of multiple distributed nodes, in which, over the course of one or more training rounds, each of the distributed nodes creates and updates its own model, and those nodes' local models may be combined into a consensus model for the system.

In distributed machine learning systems, training performance is affected by how model information is exchanged among the nodes. Specifically, in each training round, each worker node in a distributed machine learning system will take a weighted average of the models that are aggregated from its neighbors. Those weights can be stacked into a matrix called a consensus weight matrix, and it has been shown in L. Xiao and S. Boyd, “Fast linear iterations for distributed averaging,” Systems & Control Letters, vol. 53, no. 1, pp. 65-78, 2004 (hereinafter “Xiao, 2004” which document is hereby incorporated by reference in its entirety) that the convergence speed of a distributed machine learning system is governed by the second-largest singular value of the consensus weight matrix. Accordingly, in some distributed machine learning solutions, the Fastest Distributed Linear Averaging (FLDA) algorithm described in Xiao 2004, which minimizes the second-largest singular value of the consensus weight matrix have been used. Variations on the FLDA algorithm have also been proposed in the literature. The Laplacian matrix of the communication graph has been used to design a consensus weight matrix. Examples are best constant weight, maximum-degree weight, and Metropolis weight, as described in S. Boyd, P. Diaconis, P. Parrilo, and L. Xiao, “Fastest mixing Markov chain on graphs with symmetries,” SIAM Journal on Optimization, vol. 20, no. 2, pp. 792-819, 2009, which is incorporated by reference herein in its entirety.

In addition to design of a consensus weight matrix, efficient communication resource allocation can also be of importance, and some works jointly consider consensus weight matrix design and resource allocation. An example is X. Lian, C. Zhang, H. Zhang, C.-J. Hsich, W. Zhang, and J. Liu, “Can decentralized algorithms outperform centralized algorithms? A case study for decentralized parallel stochastic gradient descent,” in Proc. NeurIPS, 2017, pp. 5336-5346 which is incorporated by reference herein in its entirety.

However, there are problems associated with current approaches to improving the performance of distributed machine learning systems. For example, state of the art solutions generally focus on distributed training over a static network, and may make use of all physical links of the underlying network. This can lead to inefficient communication among the workers, especially in scenarios where limited bandwidth is shared among them, and although a more connected network may result in fewer iterations in model training, it may also introduce higher communication costs in each iteration. This is described, for example, in A. Nedic, A. Olshevsky, and M. G. Rabbat, “Network topology and communication-computation tradeoffs in decentralized optimization,” Proceedings of the IEEE, vol. 106, no. 5, pp. 953-976, 2018, which is hereby incorporated by reference in its entirety. Additionally, many state of the art solutions focus on static networks, which can limit their applicability to dynamic environments, and general solutions for online optimization may overlook the particular structure of the problems posed by the factors underlying latency in a dynamic environment. Accordingly, to address one or more of these or other issues, there is a need for improved technology in distributed machine learning systems.

### SUMMARY

The present disclosure is broadly directed to distributed machine learning in which resource allocation and weights for combining distributed node models are dynamically determined during training. For example, there is provided a method for distributed machine learning performed by an edge server. The method comprises distributing, to each of a plurality of worker nodes, a machine learning task. The method comprises, after each of a plurality of training rounds, performing a set of network topology design activities. The set of network topology design activities comprises generating data for updating control values and sending the data for updating control values to the plurality of worker nodes.

In another aspect, there is provided an edge server comprising processing circuitry and a memory. The memory contains instructions executable by the processing circuitry whereby the edge server is operative to distribute, to each of a plurality of worker nodes, a machine learning task. The memory contains instructions executable by the processing circuitry whereby the edge server is operative to, after each of a plurality of training rounds, perform a set of network topology design activities. The set of setwork topology design activities comprises generating data for updating control values, and sending the data for updating control values to a plurality of worker nodes.

In another aspect, there is provided a method for distributed machine learning performed by a worker node. The method comprises performing a set of training round acts. The set of training round acts comprises training a local machine learning model using a local dataset. The set of training round acts comprises exchanging machine learning models with a set of neighboring worker nodes. The set of training round acts comprises updating the local machine learning model using a set of weight values and the machine learning models from the set of neighboring worker nodes. The set of training round acts comprises receiving, from an edge server, data for updating control values. The set of training round acts comprises updating the set of weight values based on the data for updating control values.

In another aspect, there is provided a worker node comprising processing circuitry and a memory. The memory contains instructions executable by the processing circuitry whereby the worker node is operative to perform a set of training round acts. The set of training round acts comprises training a local machine learning model using a local dataset. The set of training round acts comprises exchanging machine learning models with a set of neighboring worker nodes. The set of training round acts comprises updating the local machine learning model using a set of weight values and the machine learning models from the set of neighboring worker nodes. The set of training round acts comprises receiving, from an edge server, data for updating control values. The set of training round acts comprises updating the set of weight values based on the data for updating control values.

In further aspects, embodiments of a system for distributed machine learning comprising one or more processors configured with instructions operable to, when executed, perform methods set forth herein are provided.

In still further aspects, embodiments of a computer program product for distributed machine learning comprising one or more non-transitory machine readable storage mediums having program instructions thereon, which are configured to, when executed by one or more processors, perform methods set forth herein are provided.

Additional benefits and advantages of the disclosed technology will be apparent in view of the following description and accompanying figures.

### BRIEF DESCRIPTION OF THE DRAWINGS

Embodiments of the present disclosure are illustrated by way of example, and not by way of limitation, in the figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following detailed description taken in connection with the appended claims and with reference to the attached drawing figures in which:

FIG. 1 depicts an example of a distributed machine learning environment;

FIG. 2 provides a graphical illustration of the impact of various nodes on distributed machine learning performance;

FIGS. 3A-3B depict a high level method for accounting for dynamic stragglers while completing a machine learning task;

FIG. 4 illustrates data an edge server may generate to define a distributed machine learning environment;

FIG. 5 illustrates a method which may be used in updating machine learning control values;

FIG. 6 illustrates a fully connected network from a distributed machine learning simulation test;

FIG. 7 illustrates a pruned and sparse network from a distributed machine learning simulation test;

FIG. 8 illustrates training latency in a distributed machine learning simulation test;

FIG. 9 illustrates dynamic regret in a distributed machine learning simulation test;

FIG. 10 illustrates accuracy of one device in a distributed machine learning simulation test;

FIG. 11 illustrates the aggregated accuracy of multiple systems in a distributed machine learning test;

FIG. 12 illustrates acts which may be performed by worker nodes and an edge server;

FIG. 13 illustrates signaling which may take place in a method performed based on this disclosure;

FIG. 14 illustrates acts which may be performed by an edge server similar to those illustrated in FIG. 3A;

FIG. 15 illustrates acts which may be performed by a worker node similar to those illustrated in FIG. 3B; and

FIG. 16 is a schematic illustration of hardware which may be used to for methods which may be performed by a worker node or edge server as described herein.

### DETAILED DESCRIPTION

As set forth herein, aspects of the disclosed technology may be used in distributed machine learning systems. As described, the disclosed technology may be implemented to reduce wall clock time of a training problem by minimizing communication costs through modifying the topology of a network made up of communication links between the worker nodes of the machine learning system. In some embodiments, these types of modifications may be made dynamically, potentially changing with each training round, thereby accounting for the fact that real world network environments may change over time. In illustrating potential implementations, this disclosure sets forth numerous specific details with respect to one or more potential embodiments. However, it should be understood that embodiments of the disclosed technology may be practiced without such specific details. Additionally, well-known circuits, subsystems, components, structures and techniques have not been shown in detail in order not to obscure the understanding of the example embodiments. Accordingly, it will be appreciated by one skilled in the art that one or more embodiments of the present disclosure may be practiced without such specific components-based details. It should be further recognized that those of ordinary skill in the art, with the aid of the detailed description set forth herein and taking reference to the accompanying drawings, will be able to make and use one or more embodiments without undue experimentation.

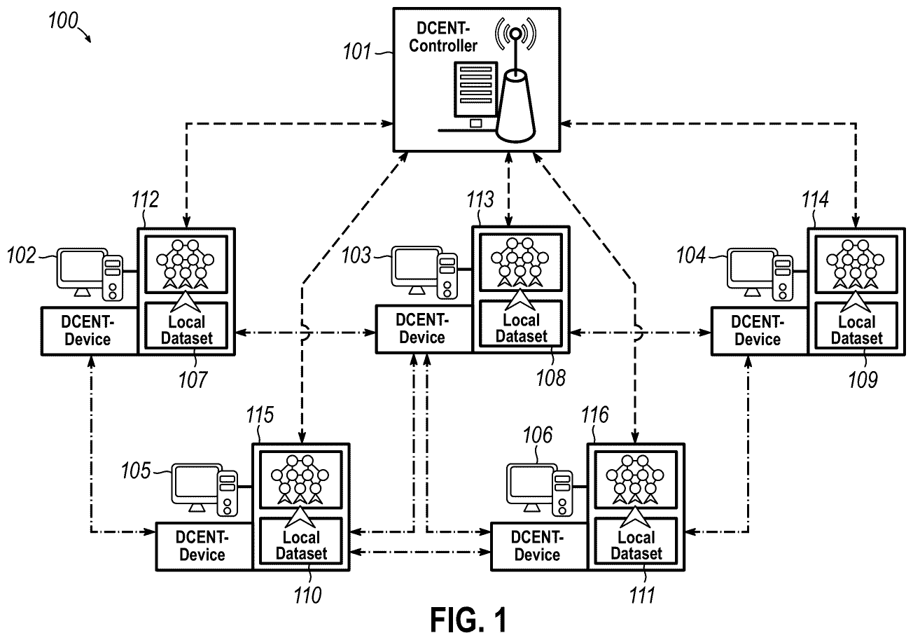

Turning now to the figures, FIG. 1 provides an example of an environment 100 in which distributed machine learning systems using the technology described herein may be implemented. As shown in FIG. 1, the disclosed technology may be implemented using an edge server 101 and a plurality of worker nodes 102 103 104 105 106. In an embodiment the edge server 101 may communicate with each of the worker nodes 102-106 through an operator wireless network such as an LTE, 5G or other type of wireless network. In other embodiments, the edge server 101 may communicate with each of the worker nodes 102-106 using a wired network, or using a combination of wired and wireless networks. Using this network, the edge server 101 may send the worker nodes 102-106 a machine learning task (i.e., training a machine learning model over a set of one or more training rounds) and/or information that the worker nodes 102-106 may use in communicating with each other and completing the task. This information may include, for each of the worker nodes 102-106, a local dataset 107 108 109 110 111 which that worker node 102-106 should process to generate a local machine learning model 112 113 114 115 116. The worker nodes 102-106, which may be implemented using servers, tablets, desktop or laptop computers, mobile phones or other types of computing devices, and which may each be the same type of device, or may be heterogenous devices, could then exchange their local machine learning models using device to device connections. Each of the worker nodes 102-106 may then update its local machine learning model 112-116 based on the machine learning models from its neighboring nodes—i.e., the nodes with which that worker node had a device to device connection (e.g., for a first worker node 102, the neighboring nodes would be the second worker node 103 and the third worker node 105). This training and updating could then be repeated one or more times (each such time being referred to herein as a “training round”) until a termination condition was satisfied, such as a predefined number of training rounds being reached, or the various local machine learning models converging.

When communicating among each other, the various devices may use various types of communication links. For example, while worker nodes 102-106 may use the same communication infrastructure to communicate with each other as with the edge server 101 (e.g., an operator wireless network), it is also possible that they may communicate with each other using orthogonal channels to communicate with their neighbors using device to device communication. For example, in some embodiments, worker nodes 102-106 may communicate with each other through Bluetooth, WiFi Direct, or LTE Direct connections. These connections may be homogenous between devices, or different devices may opportunistically use whatever type of communication channel is most appropriate given their specific relationships to each other (e.g., WiFi direct may be used at ranges of up to 200 meters, while LTE Direct may be used at ranges of between 200 and 500 meters). Additionally, while FIG. 1 illustrates various worker nodes as communicating with each other without any intermediaries, it should be understood that, in some embodiments, various worker nodes 102-106 may interact with each other through intermediaries (e.g., through a router) while still being considered connected for purposes of exchanging information such as machine learning models.

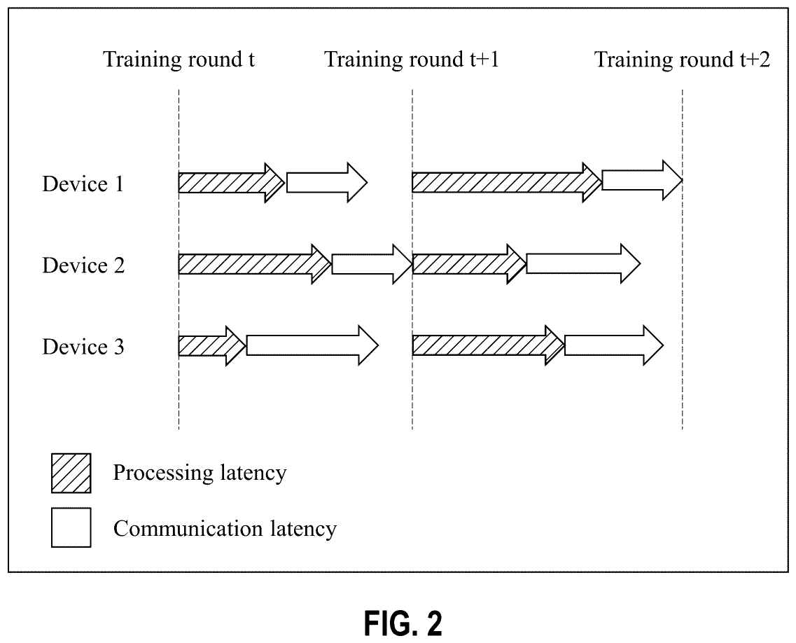

In an environment 100 such as shown in FIG. 1, the performance of the system as a whole on any particular round may be dominated by the performance of the slowest of the worker nodes 102-106, and the relative performance of those worker nodes may not be known until after the round is complete. To illustrate the impact of the slowest worker node, and how the slowest node may change over time, consider FIG. 2. That figure shows, for each of three worker nodes, that the time required for that worker node to complete its activities in any training round will be determined by the sum of the time it takes that worker node to perform calculations such as training its model (referred to as processing latency) and the time it takes to communicate its model to its neighboring nodes (referred to as communication latency). That figure also shows how the total time to complete any individual training round will be determined by the combined processing and communication latency of the slowest worker node, referred to as the straggler, and how the straggler can change from round to round. For instance, in the scenario of FIG. 2, the straggler in training round t may be device 2, while in training round t+1, the straggler may be device 1, due to changes in processing and communication latencies between rounds t and t+1. Additionally, as shown in FIG. 2, for non-straggler worker nodes, each of the training rounds may include a waiting period, during which the non-straggler nodes are neither processing nor communicating, but instead are waiting on the straggler to complete its processing and communication activities for that round. To maximize performance, implementations of techniques described herein may use various approaches to address the facts that performance of the system may be determined by the performance of the straggler, and that the straggler may change dynamically from round to round during a training task.

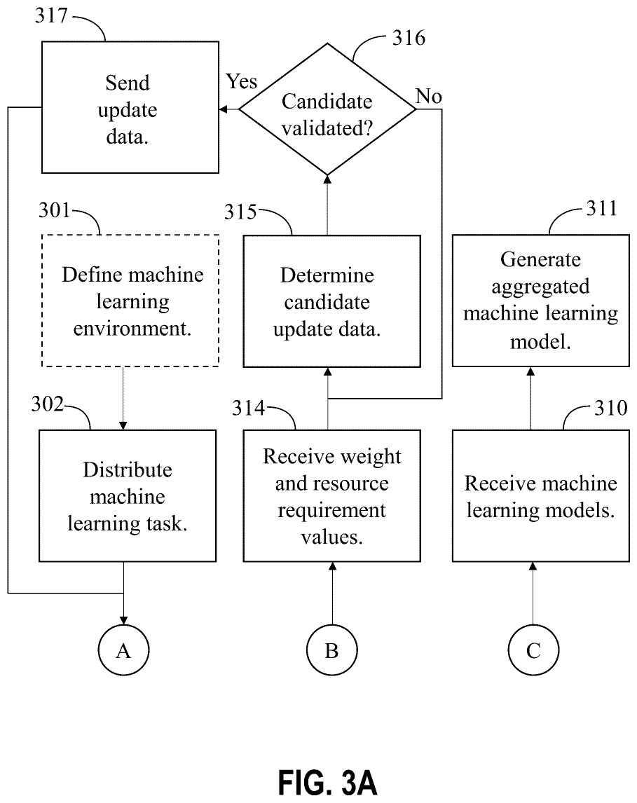

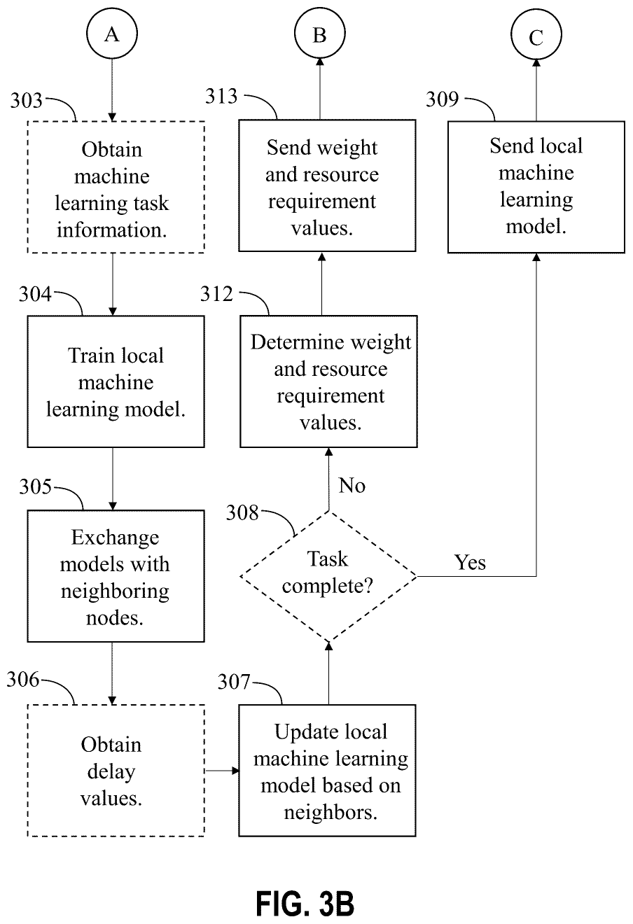

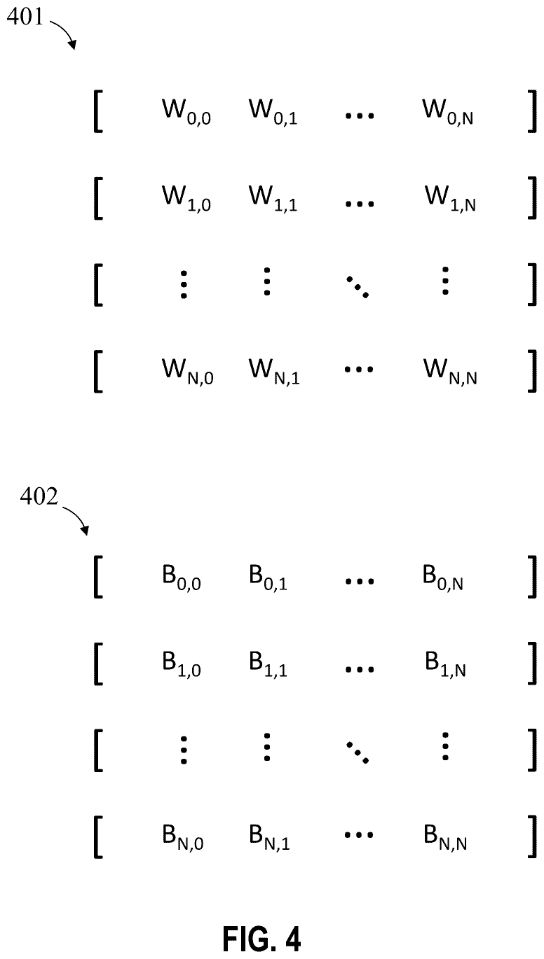

Turning now to FIGS. 3A and 3B, those figures depict a high level method for accounting for dynamic stragglers while completing a machine learning task in an environment such as that shown in FIG. 1, with FIG. 3A illustrating tasks which may be performed by an edge server 101, and FIG. 3B illustrating tasks which may be performed by worker nodes 102-106. Initially, in the method of FIGS. 3A-3B, the edge server 101 would define (block 301) the environment in which the machine learning task would be completed. To illustrate, consider a case where a server 101 was in communication with a variety of devices that could serve as worker nodes. In such a case, the server 101 may collect data regarding the devices it was in communication with, and may then use the collected data to select a subset of those devices to operate as worker nodes (e.g., those devices which the collected data indicated were likely to maintain network connections to the edge server 101 throughout the training task). It may then generate data indicating how the selected worker nodes should interact with each other. To illustrate this type of data, consider FIG. 4, discussed below, which illustrates data that an edge server 101 may generate in defining (block 301) a machine learning environment.

Turning now to FIG. 4, that figure illustrates a weight matrix 401 and a resource matrix 402 that could specify how a set of N worker nodes should weight each other's inputs when combining their local machine learning models and allocate their communication resources (e.g., bandwidth) when exchanging models with other nodes. In particular, the weight matrix 401 comprises N rows, with each row comprising a set of weight values (i.e., values used as weights for different data) a particular worker node would use in combining its local machine learning model with local machine learning models from other worker nodes. In that set of weight values, each of the values would correspond to a different worker node. When the worker node for that row was combining its local machine learning model with the local machine learning models from its neighboring worker nodes, it could multiply each of the neighboring worker nodes' machine learning models by the corresponding weight values to obtain a combined local machine learning model. The same type of approach could be taken to allow the resource values (i.e., values indicating resource allocations) in the resource matrix 402 to be used to allocate a worker node's communication resources. That is, when a worker node was exchanging machine learning models with a neighboring node, it could do so with a portion of its bandwidth specified by the corresponding value in the resource matrix 402. For example, if worker node i is exchanging machine learning models with worker node j, then worker node i could allocate bandwidth B_{i,j} from the resource matrix 402 to the task. Similarly, the resource matrix 402 may indicate that no bandwidth should be allocated to a particular communication. For example, if the value of B_{i,j} was 0, then node i may not exchange machine learning models with node j, thereby freeing up resources for other (potentially less costly) communications.

It should be understood that, while the above examples show data which may be generated by a server in defining (block 301) a machine learning environment, those examples are intended to be illustrative, and that different variations on defining (block 301) a machine learning environment may be implemented in different embodiments. For instance, while FIG. 4 indicated that there could be separate matrices for weights that should be used for combining models and resources that should be used for communication, in some cases only a single matrix may be used for this purpose. In such a case, if the value of a particular element of the weight matrix 401 was 0 (or was below some threshold), the implicated worker nodes may treat that as a sign not to exchange machine learning models, and may use their own on-board processing to determine how to allocate their communication resources to their other communication links, rather than relying on values from a resource matrix 402 for this purpose.

As another example of a type of variation which may be present between embodiments, consider the algorithms that a server may use to generate data such as weight and resource matrices as shown in FIG. 4. For instance, in some cases, a server may define these using approaches which do not consider the particular characteristics of the worker nodes, such as by stating that every worker node should equally allocate its communication resources across all other worker nodes, and should equally weight every other worker node's machine learning model. Alternatively, in some cases a server may use an approach which considers the particular characteristics of the worker nodes, such as by assuming that the links between worker nodes constituted a static network and applying a static network optimization routine to determine initial weight and resource values. As yet another example, in some cases a server may assign values such as may be included in weight and resource matrices 401 402, check if they would result in the machine learning environment satisfying a set of constraints, and then reassigning the values as necessary until the constraints are satisfied. For example, the server may assign values for weight and resource matrices, and then validate that the conditions set forth in table 1 are true.

TABLE 1

| | |
|---|---|
| 1) | a network made up of connections defined by those |
| | matrices is periodically connected (i.e., |
| | information from each worker node reaches |
| | each other worker node at least every τ training |
| | rounds, where t is some number less than the |
| | number of rounds for the training task); |
| 2) | the weight matrix 401 is column stochastic (i.e., |
| | that every value in the weight matrix was |
| | between 0 and 1, inclusive, and that for every |
| | worker node, the sum of weights in that worker |
| | node's row was equal to 1); and |
| 3) | the total resources allocated by the resource matrix |
| | 402 did not exceed the resources which |
| | actually existed. |

Other approaches to defining (block 301) the machine learning environment are also possible, and will be immediately apparent to those of skill in the art in light of this disclosure. Accordingly, the above examples, like FIG. 4 and the associated discussion, should be understood as being illustrative only, and should not be treated as limiting.

Returning now to the discussion of FIG. 3A, after the machine learning environment has been defined (block 301), the server would distribute (block 302) a machine learning task to each of the worker nodes. To illustrate what this may entail, consider a case where the disclosed technology is used to train a convolutional neural network to recognize digits using the MNIST database of handwritten digits, which is available at yann.lecun.com/exdb/mnist. Distributing (block 302) the machine learning task may also include sending worker nodes information defining their roles in the machine learning environment. This may be done by sending each of the worker nodes a weight matrix 401 and resource matrix 402 such as shown in FIG. 4. Alternatively, values such as could be used to populate weight and resource matrices 401 402 could be assembled into vectors (e.g., one vector per matrix row), and those vectors may be sent to the worker nodes. Various embodiments may also include various other types of activities in distributing (block 302) machine learning tasks. For example, in a case where the machine learning task is defined as training a machine learning model over a fixed number T of training rounds, distributing the machine learning task may include informing the worker nodes of the number of training rounds. Accordingly, depending on the specifics of a machine learning task and the roles which would be taken by the worker nodes in completing it, distributing (block 302) the machine learning task may vary from case to case, and the examples given above should be understood as illustrative only, rather than being treated as limiting.

Turning now to FIG. 3B, after it is distributed (block 302) by the server, each of the worker nodes may obtain (block 303) the machine learning task. Once the machine learning task has been obtained (block 303), each of the worker nodes may use its own data set (e.g., a local copy of some or all of the MNIST database of handwritten digits) to train (block 304) its own local machine learning model. This training may be performed using techniques known in the art, and will result in a set of values (or gradients of values) which will vary depending on the nature of the machine learning model being trained. For example, if the machine learning model being trained is a neural network, then the values could be connection weights in the neural network. Alternatively, if the machine learning model is a support vector machine, then the values could be parameters for vectors defining a hyperplane separating feature space. Other types of values may be generated by training other types of models, and will be immediately apparent to those in the art.

After the worker nodes have trained (block 304) their local machine learning models, each worker node may exchange (block 305) machine learning models with its neighboring worker nodes. For example, in a case where an edge server had distributed a resource matrix 402 such as shown in FIG. 4, each worker node could exchange machine learning models with each other worker node the resource matrix 402 indicated it was connected to, and could do so using the bandwidth indicated in the resource matrix 402. Additionally, as shown in FIG. 3B, each worker node could obtain (block 306) delay values associated with this communication, and could use the machine learning models from its neighbors to update (block 307) its own machine learning model. With respect to obtaining (block 306) delay values, in some cases this may be combined with the exchange (block 305) of machine learning models itself, with each worker node obtaining delay values for the worker nodes in its neighborhood by observing, for each of its neighboring worker nodes, the time which elapses from the beginning of the training round until the time that neighboring node is able to send its local model as part of a machine learning model exchange (i.e., the processing latency of that neighboring worker node) and the time elapsed between the beginning and end of the exchange of machine learning models with that neighboring node (i.e., the communication latency for the link between that worker node and that neighboring worker node). With respect to updating (block 307) its machine learning model, this may be done by each worker node taking a weighted average of its own model and the models received from its neighbors, using weights such as those in a weight matrix 401, and then updating (block 307) its local model through gradient descent with the weighted average.

After the worker nodes had updated (block 307) their local machine learning models, they may make a determination (block 308) of if the machine learning task was complete. For example, if the training task was to train a machine learning model over a fixed number, T, of rounds, then the determination (block 308) of whether the task was complete could be performed by comparing the number of training rounds which had taken place to the specified number of training rounds, T. Alternatively, in a case where the machine learning task was for the worker nodes to continue training their machine learning models until those models converged, a worker node may compare its machine learning model with the machine learning models received from its neighbors, and determine (block 308) that the task was complete if those models were the same, or were the same within some limit (e.g., had a least squares error of less than a threshold specified by the edge server at the beginning of the machine learning task). If the worker nodes determined (block 308) that the machine learning task was complete, they may send (block 309) their local machine learning models to the edge server. The edge server may then, as shown in FIG. 3A, receive (block 310) the machine learning models from the worker nodes, and use those models to generate (block 311) an aggregated machine learning model which could be treated as the output of the machine learning task. For example, in a case where the task was to train a neural network to recognize handwritten digits, the edge server 101 may generate (block 311) an aggregated machine learning model by generating a neural network having connection weights equal to the average of the connection weights of the neural networks generated by each of the worker nodes. This aggregated machine learning model may then be distributed to other devices for use in handwriting recognition tasks.

As an alternative to sending (block 309) their local machine learning models to the edge server, in some cases, worker nodes may perform distributed averaging of their local models to create a final aggregated model, rather than sending their local models to the edge server for that purpose. As another alternative, local machine learning models stored on the worker nodes may be used directly without being aggregated with each other (e.g., training may be continued for a sufficient number of epochs that all local machine learning models would converge without requiring additional aggregation). As yet another alternative, in a case where the worker nodes determine (block 308) that the machine learning task is not complete, they could generate data that could be used to update the machine learning environment 100 to decrease the latency of the next training round. For example, as shown in FIG. 3B, each worker node could determine (block 312) weight and resource requirement values indicating how resources and weights could be allocated from that node to the slowest device in that node's neighborhood without that node itself becoming a straggler. This may be done, for example, on a link by link basis, using equations such as equations 1 and 2, below.

$${\hat{B}}_{i , j} = D / ( {S}_{i , j} * ( ( ( {P}_{i} + {C}_{i , z} ) * {W}_{i , j} / {η}_{i , j} ) - {P}_{i} ) \qquad Equation l$$

$${\hat{W}}_{i , j} = Min ( ( ( {P}_{i} + {C}_{i , z} ) * {W}_{i , z} ) / ( {P}_{i} + \frac{D}{\overline{B} * {S}_{i , j}} ) , 1 ) \qquad Equation 2$$

In those equations, node z is the straggler node in the neighborhood of node i; n_{i,j} is the spectrum efficiency of the link between node i and node j; B_{i,j} is the amount of resources (e.g., bandwidth) that had been allocated to the link between node i and node j in the preceding training round; \hat{B}_{i,j} is the minimum amount of resources (e.g., bandwidth) that would need to have been used for the link between node i and node j if (1) the remaining resources that had been allocated to the link between node i and node j had instead been allocated to the link between node i and node z, and (2) the reallocation would not have caused the link between node i and node j to make node i the straggler in its neighborhood; W_{i,j} is the weight allocated to the machine learning model from node j by node i during the preceding training round; Ŵ_{i,j} is the maximum weight which could have been allocated to the machine learning model from node j by node i in the preceding training round without violating the requirements set forth in table 1; Pᵢ, Pⱼ and P_{z} are, respectively, the processing latencies of nodes i, j, and z in the preceding training round; and Ci,j and Ci,z are, respectively, the communication latency of the link between nodes i and j and the communication latency of the link between nodes i and z in the preceding training round; D is the amount of data exchanged by node i with each of its neighboring worker nodes during the preceding training round; B̅ is the total amount of the resource (e.g., bandwidth) available for communication by node i; and S_{i,j} and S_{i,z} are, respectively, the spectral efficiency of the link between nodes i and j and the spectral efficiency of the link between nodes i and z.

Using equations such as equations 1 and 2, each worker node could determine how, on the preceding training round, it could have allocated resources to the link with the straggler from its other links (equation 1), and how it could have increased the weights of its non-straggler neighbors such that the product of the weights and latencies for its non-straggler neighbors would not have exceeded the product of the weight and latency for its straggler neighbor (equation 2). As set forth below, this may allow the machine learning environment to intelligently update itself in a manner that minimizes bad links by both reducing the weight given to stragglers and increasing the bandwidth provided to their links so that their latency has a lower overall impact. So that this intelligent updating can be applied, after the weight and resource requirement values are determined (block 312) they can be sent (block 313) from the various worker nodes to the edge server, after which point the edge server can use those values in determining data which the various worker nodes could use to update their weights and resource allocations while ensuring that the overall environment remained suitable for completion of the relevant machine learning task.

Returning now to FIG. 3A, as shown in that figure, after the weight and resource requirement values are received (block 314), the edge server can determine (block 315) a candidate for data that the various worker nodes could use to update themselves. To illustrate, consider a case where each of the worker nodes is configured to use gradient descent to modify values in weight and resource matrices so that the behavior of the environment as a whole will improve over time. In such a case, the determining (block 315) candidate update data may comprise generating a step size (i.e., a value which decides how much to change a value when updating it) that the various worker nodes could use to update their weight and resource matrices on the next iteration of obtaining (block 303) machine learning task information. To ensure that such a step size is appropriate for updating the worker nodes' weight and resource matrices, the edge server may validate (block 316) that modifying the weight and resource matrices using the step size would not cause the network of communication links between the worker nodes to violate a machine learning constraint. These constraints may be similar to the constraints described previously with respect to determining values for initial weight and resource matrices, that the step size (α) using equations such as equations 3 and 4, below.

$$ρ ( W - a ( W - \hat{W} ) ) < 1 \qquad Equation 3$$

$${W}_{i , {s}_{i}} - α {\sum }_{j \neq {s}_{i}} ( {W}_{i , j} - {\hat{W}}_{i , j} ) \geq 0 , ∀ i \qquad Equation 4$$

In those equations, W_{i,j} and Ŵ_{i,j} have the same values as in equations 1 and 2, sᵢ is the straggler in the neighborhood of node I, and W and Ŵ are the vectors made up of the values of W_{i,j} and Ŵ_{i,j}, respectively.

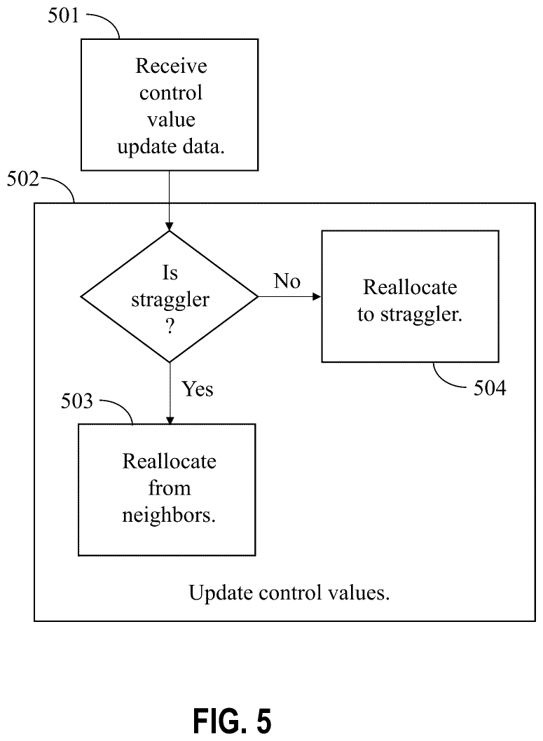

In the method of FIG. 3A, if the update data (e.g., the step size a) is not validated (block 316), then new update data may be determined (block 315), such as by modifying the previous update data in the same manner as would be done in the exact line search method for gradient descent search. Alternatively, if the update data is validated (block 316) then it may be sent (block 317) to the various worker nodes. The worker nodes may then use that update data to update their weight and resource matrices during the next iteration of obtaining (block 303) machine learning task information. A method which may be used in performing this update is illustrated in FIG. 5, discussed below.

Turning now to FIG. 5, after the control value update data (e.g., a step size) has been sent by the edge server, it would be received (block 501) by each of the worker nodes. The step size may then be used by each of the worker nodes to update (block 502) their resource and requirement matrices. If the worker node is a straggler, then this may be done by reallocating (block 503) weights and resources from its neighboring nodes to it, while if the node is not a straggler, then this may be done by reallocating (block 504) weights and resources to the straggler. Formally, this could result in resources and weights being reallocated to the stragglers as shown in equations 5 and 6, and resource and requirement matrices being updated as shown in equations 7 and 8.

$${B}_{i , {s}_{i}^{t - 1}}^{t} = 1 - {\sum }_{j \neq {s}_{i}^{t - 1}} {B}_{i , j}^{t - 1} = {B}_{i , {s}_{i}^{t - 1}}^{t - 1} - {α}^{t - 1} {\sum }_{j \neq {s}_{i}^{t - 1}} ( {\hat{B}}_{i , j}^{t - 1} - {B}_{i , j}^{t - 1} ) \qquad Equation 5$$

$${W}_{i , {s}_{i}^{t - 1}}^{t} = 1 - {\sum }_{j \neq {s}_{i}^{t - 1}} {W}_{i , j}^{t - 1} = {W}_{i , {s}_{i}^{t - 1}}^{t - 1} - {α}^{t - 1} {\sum }_{j \neq {s}_{i}^{t - 1}} ( {W}_{i , j}^{t - 1} - {\hat{W}}_{i , j}^{t - 1} ) \qquad Equation 6$$

$${B}^{t} = {B}^{t - 1} - {α}^{t - 1} ( {B}^{t - 1} - {\hat{B}}^{t - 1} ) \qquad Equation 7$$

$${W}^{t} = {W}^{t - 1} - {α}^{t - 1} ( {W}^{t - 1} - {\hat{W}}^{t - 1} ) \qquad Equation 8$$

In those equations, B^{t} and W^{t} are the matrices showing the resource allocations and weights which would be used the next time machine learning models were exchanged (block 305) and updated (block 307); α^{t-1} is a step size calculated using data from the preceding training round; B^{t-1} and W^{t-1} are the matrices showing the resource allocations and weight used in the preceding training round; \hat{B}^{t-1} is the matrix of \hat{B}_{i,j} values from the preceding training round; Ŵ^{t-1} is the matrix of Ŵ_{i,j} values from the preceding training round; and sᵢ^{t-1} is the straggler in the neighborhood of the preceding training round.

Of course, it should be understood that other types of control value updates are also possible, and may be utilized in some embodiments of the disclosed technology. For example, in some cases, rather than calculating and sending a single step size to all worker nodes, an edge server may calculate a N×N step size matrix, where the matrix elements would be step size values for individual connections, thereby allowing for benefits such as more fine grained control of communication links. As another example, in some cases, if the reallocation of weights results in the connection from one node to another falling below some threshold value (or reaching 0), then this may be seen as an indication that that connection should be broken, in which case the resources allocated to that connection may be reduced to 0 and reallocated to connections with other neighboring nodes. As another example, in some cases, rather than simply sending a step size to worker nodes and requiring the worker nodes to update their local data based on the step size, an edge server may generate new resource and weight matrices and then send the updated resource and weight values (as opposed to a step size for creating those weight and resource requirement values) to the worker nodes. Accordingly, the above description of worker nodes updating control values using a step size received from an edge server should be understood as being illustrative only, and should not be treated as limiting.

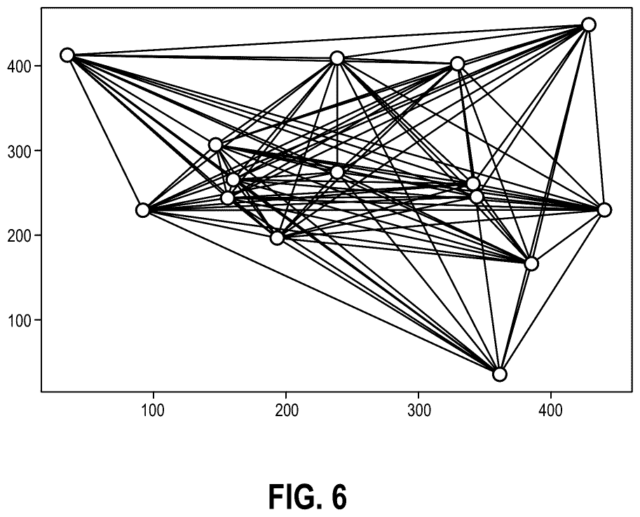

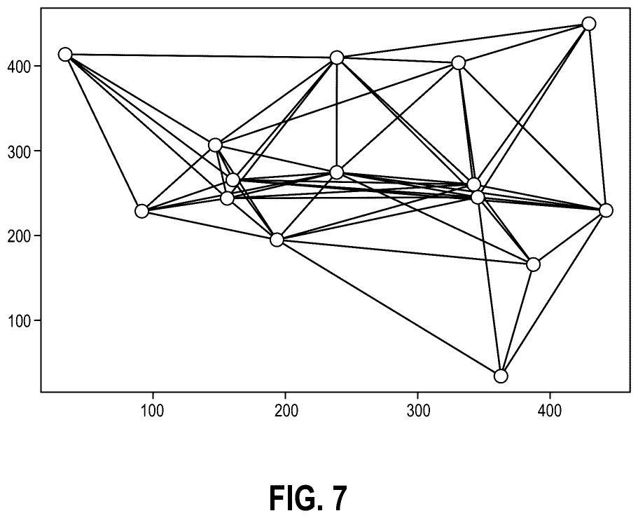

However they had been obtained, the updated control values may then be used in exchanging (block 305) and updating (block 307) machine learning models, and the process shown in FIGS. 3A and 3B may repeat until it was determined (block 308) that the machine learning task was complete. This may result in a machine learning environment which dynamically changes across training rounds, with slower connections between worker nodes being pruned, thereby increasing the efficiency of the machine learning process. Indeed, to illustrate the potential performance improvement which may result from application of the disclosed technology, consider a simulation test which 15 worker nodes are randomly distributed in a 500 m×500 m area, and moved within that area at a velocity of 0.1 meters/training round. For the machine learning task of training LeNet using the MNIST dataset. In this test, the dataset was randomly distributed to the worker nodes, each of which had six class labels. The computation time (i.e., processing latency on each training round) of each of the devices followed a normal distribution between 0 and 2 seconds. The communication model followed the Shannon Theorem. In this experiment, application of the disclosed techniques resulted in significant pruning of device-device connection in the machine learning environment, which can be seen by comparing FIG. 6, which shows a fully connected network of worker nodes, with FIG. 7, which shows the connections at the end of the machine learning task when only 109 out of a possible 210 device to device connections were selected.

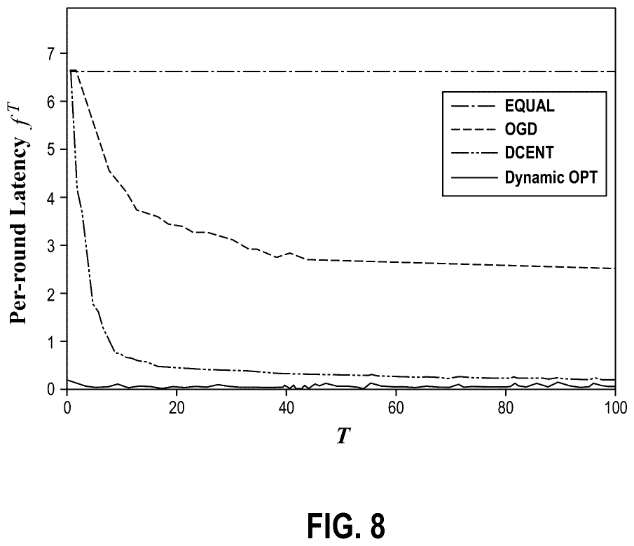

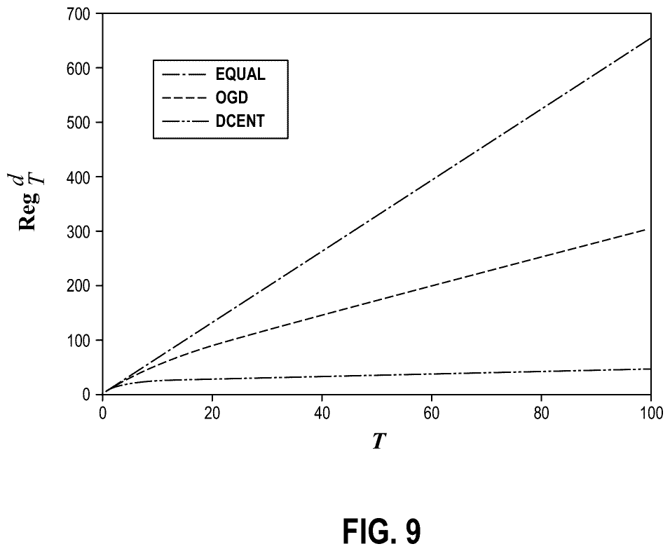

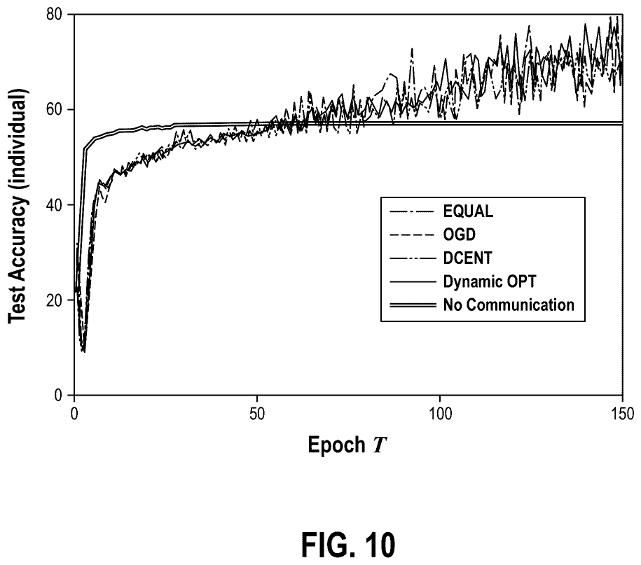

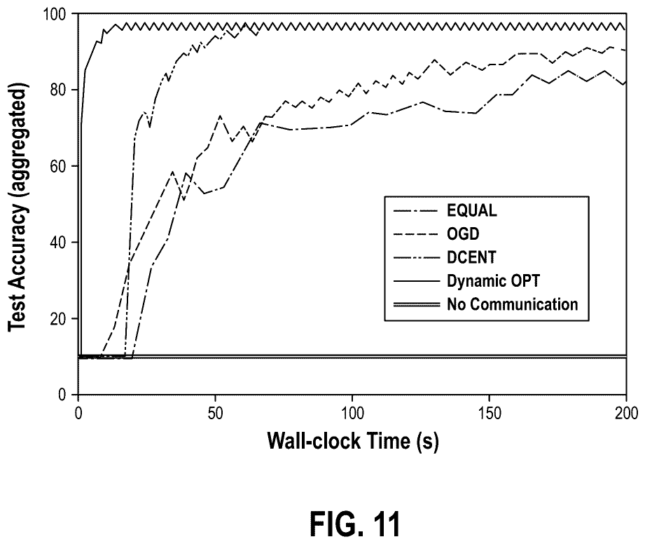

The pruning illustrated in FIGS. 6 and 7 is associated with significant decreases in wall-clock time, as can be seen in FIGS. 8 and 9, which show training latency and dynamic regret of a system implemented to use decentralized weight and resource reallocation as described herein (DCENT) relative to the following benchmarks:
Online gradient descent (OGD): In each round, the decision variable is updated with the sub gradient of the objective function in the previous round.
Equal allocation (EQUAL): Resources are equally shared among all devices. The consensus weight matrix is set as 11^{T}/N, which corresponds to a fully connected network and each of the element is 1/N.
Dynamic optimal (Dynamic OPT): an a priori knowledge of all system variables is assumed. This is also the comparator in the definition of dynamic regret.
No communication: Devices do not communicate with neighbors and independently train the model with local datasets.
   Additionally, this decrease in wall-clock time for training was not associated with a decrease in accuracy, which can be seen in FIGS. 10 and 11. In those figures, FIG. 10 illustrates the accuracy of one device over 150 training rounds. As shown in that figure, without communication, the accuracy over the test set containing 10 labels can only reach 60%, since the model is trained on a local dataset containing only six labels. With communication, devices can exchange information, potentially achieving accuracy of over 80%. This is illustrated in FIG. 11, which shows the aggregated accuracy of the disclosed technology and the relevant benchmarks over 200 seconds of wall clock time.

While this disclosure has provided various examples of ways in which distributed machine learning technology can be implemented in a dynamic network environment, it should be understood that the examples provided herein are intended to be illustrative only, and that the techniques described in this can be applied in other ways as well. For example, consider the relationship between the edge server 101 and the worker nodes 102-106. While FIG. 1 illustrates the edge server 101 as separate from the worker nodes 102-106, in some cases it is possible that a single device may both perform the functions of the edge server 101 and the functions of a worker node. In such a case, when it was necessary for another worker node to communicate with that device (i.e., the device which filled both the worker node and edge server roles), that worker node could use a device to device connection if the communication was one that one worker node may have with another, or may use an operator wireless network if the communication was one that the worker node would have with an edge server. In this way, even if the connection between two worker nodes was pruned (e.g., based on the weight of the link between those worker nodes falling below a threshold), communications between those worker nodes could still be transmitted to the extent necessitated by one of those nodes taking the role of edge server.

As another example of how distributed machine learning technology such as described herein could be implemented, consider potential use cases where implementation of the disclosed technology may be applied. For instance, while the above discussion gave the example use case of training a machine learning model to perform handwriting recognition using the MNIST dataset, the disclosed technology is not limited to that application, and could be applied to other use cases as well. For example, in a case where worker nodes were provided with a dataset comprising annotated traffic packets, that data could be used to train a machine learning model to perform anomaly detection. As another example, in a case where worker nodes were provided with text data, such as a dump of Wikipedia articles as available from https://dumps.wikimedia.org, that data could be used to train a large language model, like a generative transformer. In general, the technology disclosed herein is agnostic to particular tasks that would be performed by the machine learning models it would be used to train, and so the example use case of training a machine learning model to perform handwriting recognition using the MNIST dataset should be understood as being illustrative only, and should not be treated as limiting.

As yet a further example of a type of variation on how the disclosed technology may be implemented, consider resources which may be (re)allocated to reduce the impact of stragglers on the overall performance of a distributed machine learning system. For instance, in a case where a worker node may have multiple simultaneous tasks (e.g., multiple processes, or multiple threads in a single process), a system implemented based on this disclosure may re-allocate its processing resources (e.g., processor time) from one task to another in the same manner as described previously for reallocating bandwidth from one neighboring node to another. Similarly, in some cases, a worker node may reallocate communication resources other than bandwidth (e.g., battery power for a receiver) in order to optimize its communication latency and reduce its waiting period during any particular training round. It is also possible that multiple resources may be jointly optimized in some embodiments, for example, by representing resources as vectors of different types of resources (e.g., processor time, bandwidth, etc.) rather than as simple resource values in equations such as equations 1-8 discussed above. Other variations are also possible, could be implemented by, and will be immediately apparent to, those of ordinary skill in the art in light of this disclosure. Accordingly, the examples and illustrations provided in this disclosure should not be understood as implying limitations on the protection provided by this document or any related document.

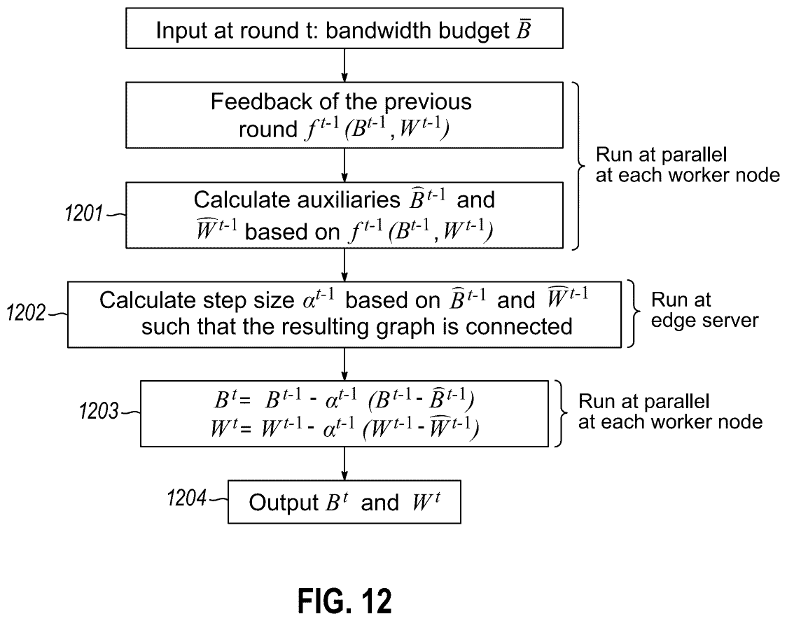

To further expand on how the disclosed technology may be implemented in practice, FIGS. 12-15 provide alternative illustrations of methods which may be performed by systems implemented based on this disclosure. Starting with FIG. 12, that figure illustrates acts which may be performed by worker nodes and an edge server to update resource matrices and weight matrices. These acts could include, at each training round t, each worker node taking a total amount of a resource available for a machine learning task as well as feedback from a preceding training round, to calculate (block 1201) matrices \hat{B}^{t-1} and Ŵ^{t-1}, which, as discussed above in the context of equations 5-8, may be used to calculate the values for weight and resource matrices to be used during training round t. As shown in FIG. 12, the total amount of a resource available for the machine learning task may be represented as a bandwidth budget, B̅, which is a total amount of bandwidth that can be devoted by a worker node to communicating with its neighbors). Similarly, the feedback from the preceding training round could be represented by a function ƒ^{t-1}(B^{t-1}, W^{t-1}), representing the latency at the preceding round that resulted from performing the training round activities using the bandwidth and weight matrices B^{t-1} and W^{t-1}. Once the matrices \hat{B}^{t-1} and Ŵ^{t-1} were calculated, they could be sent to the edge server, and it could use them to calculate (block 1202) a step size α^{t-1}, such as by using a procedure as described previously in the context of blocks 315 and 316 of FIG. 3A. The edge server could then send the step size α^{t-1} to each of the worker nodes (e.g., as described in the context of block 317 in FIG. 3A), and the worker nodes could use it to calculate (block 1203) weight and resource requirement matrices B^{t} and W^{t}, such as using equations 7 and 8 which were discussed previously in the context of FIG. 3B. Those matrices could then be provided as output (block 1204) from the calculation function used by the worker node, and could be used in performing the machine learning task during training round t.

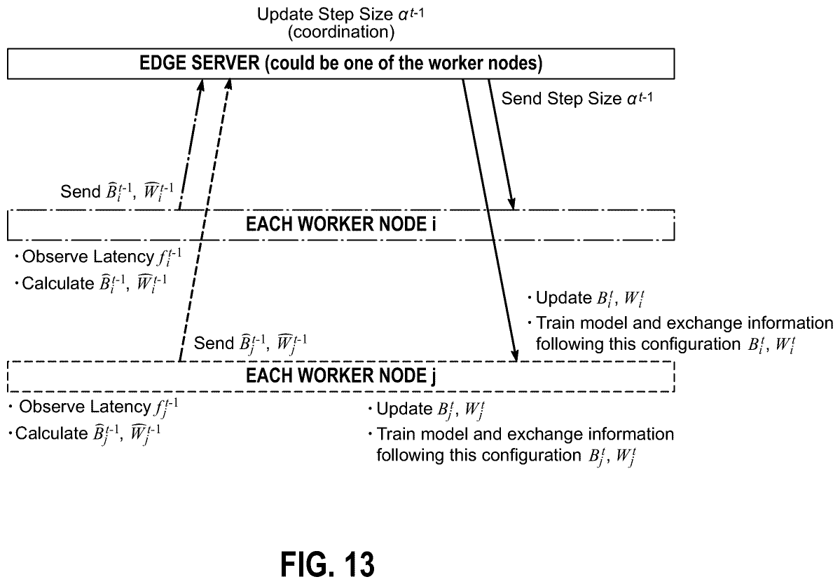

Turning next to FIG. 13, that figure provides yet another illustration of a method which could be performed based on this disclosure, with that figure focusing specifically on signaling. In particular, as shown in FIG. 13, in each training round, each worker node i and j may observe the latency of the devices in its neighborhood (represented as ƒᵢ^{t-1} and ƒⱼ^{t-1}), and may use this information to calculate matrices (\hat{B}ᵢ^{t-1}, \hat{B}ⱼ^{t-1}, Ŵᵢ^{t-1}, Ŵⱼ^{t-1}) indicating how its weights and resource allocations may be transferred to the neighborhood straggler without causing the node doing the shifting to become the straggler itself. These matrices could be sent by the worker nodes to the edge server, and the edge server could use them to calculate a step size α^{t-1} (e.g., as described previously in the context of blocks 315 and 316 of FIG. 3A). The edge server could then send this step size α^{t-1} to the worker nodes. Once they had received the updated step size α^{t-1} from the edge server, the worker nodes could use it to update their weight and resource matrices (Wᵢ^{t}, Wⱼ^{t}, Bᵢ^{t}, Bⱼ^{t}), and then use those updated matrices to train their local machine learning models and then exchange those models with their neighbors. This could then be repeated for multiple training rounds until the machine learning task was complete (e.g., when the various nodes' local machine learning models converged), at which point each of the worker nodes may send its local machine learning model to the edge server (not shown in FIG. 13) to be used in practice for whatever task it was trained to perform.

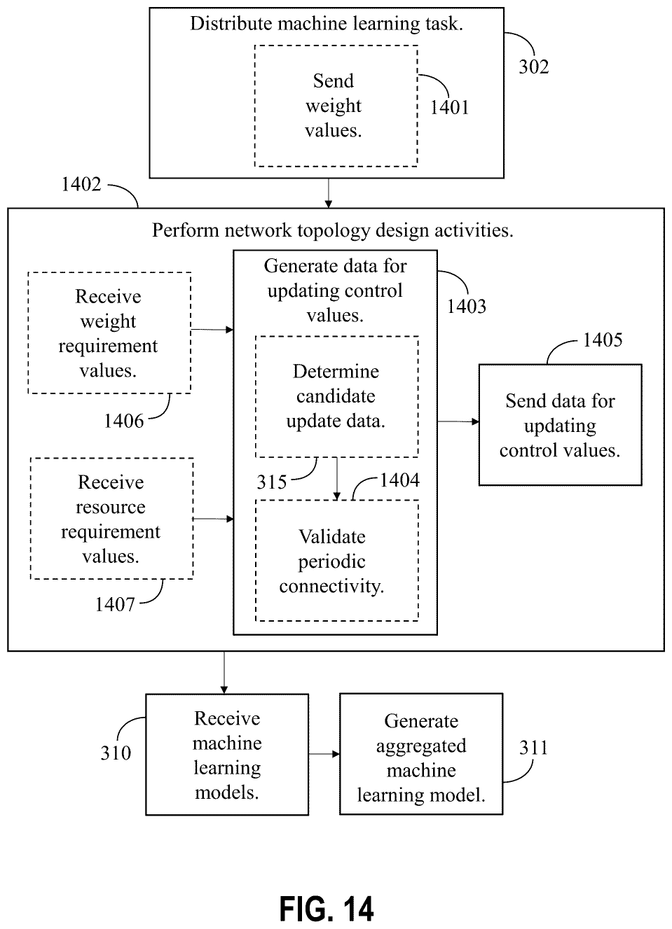

Turning next to FIG. 14, that figure provides an illustration of acts which may be performed by an edge server, similar to those discussed previously in the context of FIG. 3A. As shown in FIG. 14, this method may include distributing a machine learning task to a plurality of worker nodes in a manner such as described in the context of block 302 of FIG. 3A, and this distribution may include sending (block 1401) weight values such as values which may be included in the weight matrix 401 of FIG. 4. After the machine learning task has been distributed (block 302), the method may proceed with performance (block 1402) of a set of network topology design activities. These network topology design activities may include receiving (blocks 1406 and 1407) weight and resource requirement values (e.g., as described for block 314 in the context of FIG. 3A), and using them for generating data for updating control values (block 1403)—i.e., data which is used for controlling the operation of worker nodes, such as step sizes which can be used for updating weight and resource matrices used by worker nodes for combining machine learning models and communicating with each other. This generation of data for updating control values (block 1403) may be performed by, in a manner similar to that described previously in the context of blocks 315 and 316 of FIG. 3A, determining candidate update data (block 315) and validating (block 1404) periodic connectivity of a network generated by, for each of the plurality of nodes, that node using the candidate update data to update its control values (e.g., weight and/or resource values). Once the data for updating control values had been generated (block 1403), the data for updating control values could be sent (block 1405) to the plurality of worker nodes. After these network topology design activities had been repeated one or more times (e.g., after the machine learning models at the worker nodes had converged), the edge server may receive (block 310) machine learning models from the plurality of worker nodes, and use them to generate an aggregated machine learning model (block 311) in the same manner as described above for those acts in the context of FIG. 3A.

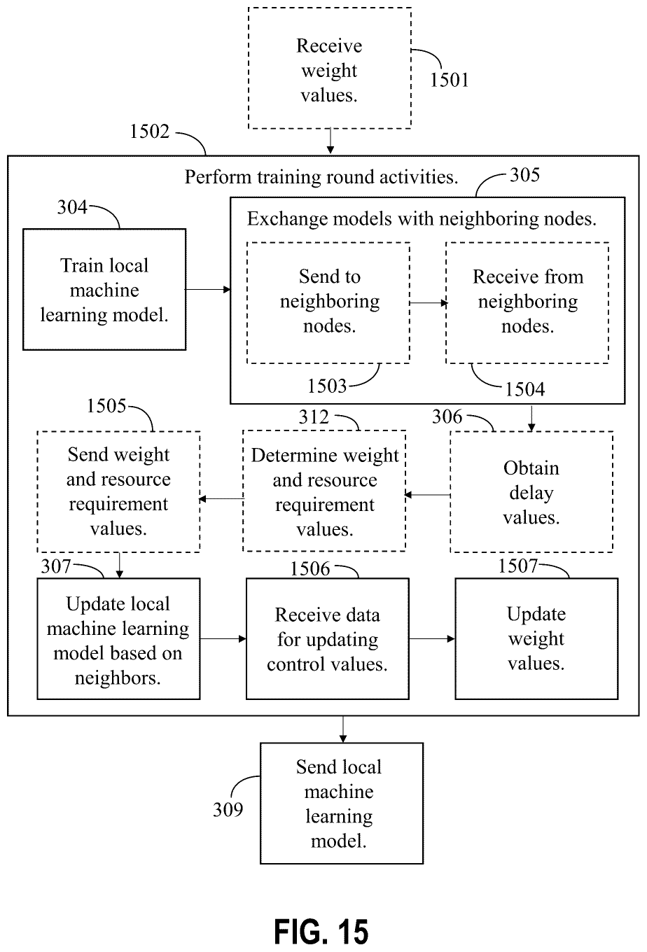

With respect to FIG. 15, just as FIG. 14 illustrates acts which may be performed by an edge server similar to FIG. 3A, FIG. 15 illustrates acts which may be performed by a worker node similar to FIG. 3B. As shown in FIG. 15, such a method may begin with the worker node receiving (block 1501) weight values, such as values which may be sent by an edge server as described for block 1401 in the context of FIG. 14. With the set of weight values received (block 1501), the worker node may perform (block 1502) a set of training round acts. These training round acts may comprise training (block 304) a local machine learning model using a local dataset, e.g., training a convolutional neural network to recognize handwritten digits using at least a portion of the MNIST dataset. Once the local machine learning model had been trained (block 304), the worker node may exchange (block 305) machine learning models with its neighboring nodes. As shown in FIG. 15, this exchanging (block 305) may include the worker node sending (block 1503) its local machine learning model to each of its neighboring worker nodes, and receiving (block 1504) corresponding machine learning models (i.e., machine learning models being trained by the neighboring worker nodes in the same machine learning task) from those neighboring nodes. In connection with this exchange (block 305), the worker node may also obtain (block 306) delay values—e.g., values showing the time spent by the worker node's neighboring nodes in training their machine learning models and exchanging them with that worker node—which values may be obtained by simple observation of when the exchanges between the worker node and its neighboring nodes are completed.

In the method of FIG. 15, the worker node may use the delay values to determine (block 312) weight and resource requirement values, e.g., as described previously in the discussion of block 312 in the context of FIG. 3B. These weight and resource requirement values may be, respectively, values identifying weight maxima for combining the worker node's local machine learning model with machine learning models from neighboring nodes corresponding to the weight requirement values, and values identifying resource minima for communication between that worker node and the neighboring nodes corresponding to the resource requirement values. Once these values have been determined (block 312), the worker node may send (block 1505) them to an edge server, which may use them in generating data for updating control values (block 1403) as described previously in the context of FIG. 14.

In addition to determining (block 312) and sending (block 1505) its weight and resource requirement values, a worker node performing a method as shown in FIG. 15 may update (block 307) its local machine learning model using its set of weight values as well as the machine learning models from the set of neighboring nodes (e.g., through use of gradient descent with a weighted average as described in the context of FIG. 3B). The worker node may also receive (block 1506) data for updating its control values (e.g., weight values used for updating the worker node's local machine learning model based on machine learning models from its neighboring nodes), and may then use that data for updating (block 1507) its local weight values, e.g., using a step size received from the edge server, as described previously in the context of FIG. 5. Finally, once the task of training its local machine learning model was complete (e.g., after the training round activities had been performed (block 1502) two or more times and resulted in a convergence of machine learning models across worker nodes), the worker node could send (block 309) its local machine learning model to the edge server (e.g., so that the edge server could generate an aggregated machine learning model as described in the context of block 311).

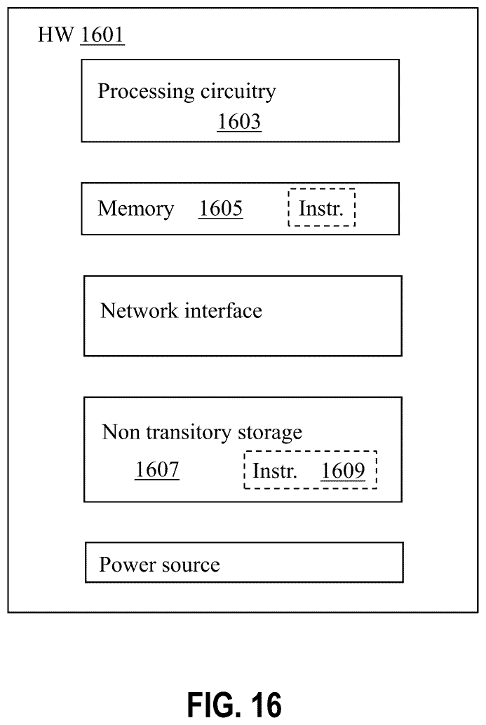

Referring to FIG. 16, there is provided a device (HW) 1601, which could be used to implement edge servers and/or worker nodes as described herein. The device 1601 (which may go beyond what is illustrated in FIG. 16), may be a user device, such as a smartphone, tablet, computer, wearable, connected vehicle, including but not limited to bicycle, car, truck, plane, drone, etc. The device 1601 may be a server, network node, radio base station, or other computing device which may be part of a cloud computing system, edge computing system, or which may be a standalone device. The device 1601 may be an internet of things (IoT) device. The IoT device may be a sensor, e.g. a thermometer or any detector for detecting environmental conditions, a camera, medical sensor, fitness tracker, etc. The IoT device may be a gaming console, refrigerator, printer, smart thermostat, smart TV, voice control device, lighting appliance, smart doorbell, alarm system, home robot, etc. In each case, such a device may perform acts such as described above to improve the efficiency of a distributed machine learning environment.

As shown in FIG. 16, a device 1601 comprises processing circuitry 1603 and memory 1605. The memory 1605 can contain instructions executable by the processing circuitry 1603 whereby functions and steps described herein may be executed to provide any of the relevant features and benefits disclosed herein. The device 1601 may also include non-transitory, persistent, machine-readable storage media 1607 having stored therein software and/or instruction 1609 executable by the processing circuitry 1603 to execute functions and steps described herein. The device may also include network interface(s) and a power source. The instructions 1609 may include a computer program for configuring the processing circuitry 1603. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

In the above-description of various embodiments of the present disclosure, it is to be understood that the terminology used herein is for the purpose of describing particular embodiments only and is not intended to be limiting on the scope of protection provided by this or any related document. Unless otherwise defined, all terms (including technical and scientific terms) used herein have the same meaning as commonly understood by one of ordinary skill in the art to which this invention belongs as shown by a general purpose dictionary.

At least some example embodiments are described herein with reference to block diagrams and/or flowchart illustrations of computer-implemented methods, apparatus (systems and/or devices) and/or computer software. It is understood that a block of the block diagrams and/or flowchart illustrations, and combinations of blocks in the block diagrams and/or flowchart illustrations, can be implemented by computer program instructions that are performed by one or more computer circuits. Such computer program instructions may be provided to a processor circuit of a general purpose computer circuit, special purpose computer circuit, and/or other programmable data processing circuit to produce a machine, so that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Additionally, the computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

Further illustrations of potential implementations and variations are provided by the examples below, which relate to various non-exhaustive ways in which the teachings herein may be combined or applied. It should be understood that the following examples are not intended to restrict the coverage of any claims that may be presented at any time in this document or in subsequent filings based on this document. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this document or any related document that include additional features beyond those referred to below, those additional features shall not be presumed to have been added for any reason relating to patentability

Referring again to FIG. 14, there is provided a method for distributed machine learning performed by an edge server. The method comprises distributing, step 302, to each of a plurality of worker nodes, a machine learning task. The method comprises after each of a plurality of training rounds, performing, step 1402, a set of network topology design activities. The set of network topology design activities comprises: generating, step 1403, data for updating control values and sending, step 1405, the data for updating control values to the plurality of worker nodes. The data for updating control values may be a step size.

The machine learning task may comprise each of the plurality of worker nodes training a local machine learning model corresponding to that worker node using a set of training data corresponding to that worker node.

The set of network topology design activities may comprise receiving, step 1406, one or more sets of weight requirement values, where each of the one or more sets of weight requirement values is received, step 1406, from a corresponding worker node from the plurality of worker nodes. For each set of weight requirement values, each weight requirement value from that set of weight requirement values may correspond to a different worker node from the plurality of worker nodes. For each set of weight requirement values, each weight requirement value from that set of weight requirement values may identify a weight maximum which the worker node from which that set of weight requirement values was received could have used on a preceding training round to combine the local machine learning model corresponding to the worker node from which that set of weight requirement values was received with the local machine learning model corresponding to the different worker node corresponding to that weight requirement value.

The data for updating control values may be data for updating parameters used by the plurality of worker nodes to communicate and combine their corresponding local machine learning models. Additionally, generating, step 1403, data for updating control values may be performed based on the one or more sets of weight requirement values.

The method may comprise receiving, step 310, a plurality of machine learning models and generating, step 311, an aggregated machine learning model based on the plurality of machine learning models. Additionally, the plurality of machine learning models may comprise, for each worker node from the plurality of worker nodes, a local machine learning model corresponding to that worker node.

Receiving, step 310, the plurality of machine learning models and generating, step 311, the aggregated machine learning model may both be performed after the set of network design topology activities has been performed two or more times.

The method may comprise, on each training round from the plurality of training rounds: training, step 304, a local machine learning model corresponding to the edge server using a set of training data corresponding to the edge server. The method may also comprise, on each training round from the plurality of training rounds, exchanging, step 305, machine learning models with a set of neighboring worker nodes for the edge server. The method may also comprise, on each training round from the plurality of training rounds, updating, step 307, the local machine learning model using a set of weight values and the machine learning models received from the set of neighboring worker nodes for the edge server. The method may also comprise, one each training round from the plurality of training rounds, updating, step 1507, the set of weight values based on the data for updating control values. The aggregated machine learning model may be generated, step 310, based on the received plurality of machine learning models and the local machine learning model corresponding to the edge server.

The set of network topology design activities may comprise determining the data for updating control values by performing a set of acts. The set of acts may comprise determining, step 315, candidate data for updating control values based on, for each of the plurality of worker nodes, time taken by that node during a directly preceding training round to calculate the local machine learning model corresponding to that worker node and communicate the local machine learning model corresponding to that worker node to each of a set of neighboring worker nodes for that worker node in the plurality of worker nodes. The set of acts may also comprise validating, step 1404, periodic connectivity of a network generated by, for each of the plurality of worker nodes, that worker node using the candidate data for updating control values to update a set of weight values used by that worker node to combine the local machine learning model corresponding to that worker node with local machine learning models corresponding to other nodes from the plurality of nodes.

The method may also comprise sending, step 1401, to each of the plurality of worker nodes, the set of weight values used by that worker node to combine the local machine learning model corresponding to that worker node with the local machine learning models corresponding to other nodes from the plurality of nodes. Additionally, for each of the plurality of worker nodes, the set of neighboring worker nodes for that worker node in the plurality of worker nodes may be worker nodes identified as connected to that worker node by the set of weight values used by that worker node to combine the local machine learning model corresponding that worker node with the local machine learning models corresponding to other nodes from the plurality of nodes.

The set of network topology design activities may comprise receiving, step 1407, one or more sets of resource requirement values. Each of the one or more sets of resource requirement values may be received, step 1407, from a corresponding worker node from the plurality of worker nodes. For each set of resource requirement values, each resource requirement value from that set of resource requirement values may correspond to a different worker node from the plurality of worker nodes. For each set of resource requirement values, each resource requirement value from that set of resource requirement values may identify a resource minimum for communication between the worker node from which that set of resource requirement values was received and the different worker node corresponding to that resource requirement value.

For each set of resource requirement values, for each resource requirement value from that set of resource requirement values, the resource minimum identified by that resource requirement value may be a bandwidth minimum.

There is also provided an edge server comprising processing circuitry and a memory, the memory containing instructions executable by the processing circuitry whereby the edge server is operative to perform a set of acts. The set of acts may comprise distributing, step 302, to each of a plurality of worker nodes, a machine learning task. The set of acts may also comprise, after each of a plurality of training rounds, performing, step 1402, a set of network topology design activities. The set of network topology design activities may comprise generating, step 1403, data for updating control values. The set of network topology design activities may also comprise sending, step 1405, the data for updating control values to the plurality of worker nodes.

The data for updating control values may be a step size.

The machine learning task may comprise each of the plurality of worker nodes training a local machine learning model corresponding to that worker node using a set of training data corresponding to that worker node.

The set of network topology design activities may comprise receiving, step 1406, one or more sets of weight requirement values. Each of the one or more sets of weight requirement values may be received, step 1406, from a corresponding worker node from the plurality of worker nodes. For each set of weight requirement values, each weight requirement value from that set of weight requirement values may correspond to a different worker node from the plurality of worker nodes. For each set of weight requirement values, each weight requirement value from that set of weight requirement values may identify a weight maximum which the worker node from which that set of weight requirement values was received could have used on a preceding training round to combine the local machine learning model corresponding to the worker node from which that set of weight requirement values was received with the local machine learning model corresponding to the different worker node corresponding to that weight requirement value.

The data for updating control values may be data for updating parameters used by the plurality of worker nodes to communicate and combine their corresponding local machine learning models. Generating, step 1403, data for updating control values is performed based on the one or more sets of weight requirement values.

The set of acts may comprise receiving, step 310, a plurality of machine learning models. The set of acts may also comprise generating, step 311, an aggregated machine learning model based on the plurality of machine learning models. Additionally, the plurality of machine learning models may comprise, for each worker node from the plurality of worker nodes, a local machine learning model corresponding to that worker node.

Receiving, step 310, the plurality of machine learning models and generating, step 311, the aggregated machine learning model may both performed after the set of network design topology activities has been performed two or more times.

The edge server may be operative to, on each training round from the plurality of training rounds, train, step 304, a local machine learning model corresponding to the edge server using a set of training data corresponding to the edge server. The edge server may be operative to, on each training round from the plurality of training rounds, exchange, step 305, machine learning models with a set of neighboring worker nodes for the edge server. The edge server may be operative to, on each training round from the plurality of training rounds, update, step 307, the local machine learning model using a set of weight values and the machine learning models received from the set of neighboring worker nodes for the edge server. The edge server may be operative to, on each training round from the plurality of training rounds, update, step 1507, the set of weight values based on the data for updating control values. The aggregated machine learning model may be generated (311) based on the received plurality of machine learning models and the local machine learning model corresponding to the edge server.

The set of network topology design activities may comprise determining the data for updating control values by performing acts comprising determining, step 315, candidate data for updating control values based on, for each of the plurality of worker nodes, time taken by that node during a directly preceding training round to calculate the local machine learning model corresponding to that worker node and communicate the local machine learning model corresponding to that worker node to each of a set of neighboring worker nodes for that worker node in the plurality of worker nodes. The set of network topology design activities may also comprise determining data for updating control values by performing acts comprising validating, step 1404, periodic connectivity of a network generated by, for each of the plurality of worker nodes, that worker node using the candidate data for updating control values to update a set of weight values used by that worker node to combine the local machine learning model corresponding to that worker node with local machine learning models corresponding to other nodes from the plurality of nodes.

The edge server may be operative to send, step 1401, to each of the plurality of worker nodes, the set of weight values used by that worker node to combine the local machine learning model corresponding to that worker node with the local machine learning models corresponding to other nodes from the plurality of nodes. For each of the plurality of worker nodes, the set of neighboring worker nodes for that worker node in the plurality of worker nodes may be worker nodes identified as connected to that worker node by the set of weight values used by that worker node to combine the local machine learning model corresponding that worker node with the local machine learning models corresponding to other nodes from the plurality of nodes.

The set of network topology design activities may comprise receiving, step 1407 one or more sets of resource requirement values. Each of the one or more sets of resource requirement values may be received, step 1407, from a corresponding worker node from the plurality of worker nodes. For each set of resource requirement values, each resource requirement value from that set of resource requirement values corresponds to a different worker node from the plurality of worker nodes. For each set of resource requirement values, each resource requirement value from that set of resource requirement values may identify a resource minimum for communication between the worker node from which that set of resource requirement values was received and the different worker node corresponding to that resource requirement value.

For each set of resource requirement values, for each resource requirement value from that set of resource requirement values, the resource minimum identified by that resource requirement value may be a bandwidth minimum.

Referring to FIG. 15, there is provided a method for distributed machine learning performed by a worker node. The method may comprise performing, step 1502, a set of training round acts. The set of training round acts may comprise training, step 304, a local machine learning model using a local dataset. The set of training round acts may comprise exchanging, step 305, machine learning models with a set of neighboring worker nodes. The set of training round acts may comprise updating, step 307, the local machine learning model using a set of weight values and the machine learning models from the set of neighboring worker nodes. The set of training round acts may comprise receiving, step 1506, from an edge server, data for updating control values. The set of training round acts may comprise updating, step 1507, the set of weight values based on the data for updating control values.

The method may comprise sending, step 309, the local machine learning model to the edge server. The method may also comprise repeating the set of training round acts one or more times. Additionally, sending, step 309, the local machine learning model to the server may be performed after repeating the set of training round acts one or more times.

The data for updating control values may be a step size.

The worker node may comprise a memory storing the set of weight values and the local machine learning model.

Exchanging, step 305, machine learning models with the set of neighboring worker nodes may comprise, for each worker node from the set of neighboring worker nodes, sending, step 1503, the local machine learning model to that neighboring worker node. Exchanging, step 305, machine learning models with the set of neighboring worker nodes may also comprise receiving, step 1504, a corresponding machine learning model from that neighboring worker node.

Each worker node from the set of neighboring worker nodes may be identified as a connected worker node in the set of weight values.

The set of training round activities may comprise obtaining, step 306, a set of delay values. The set of delay values may comprise, for the worker node and each worker node from the set of neighboring worker nodes, a time spent by that worker node in machine learning model training and exchanging. The set of training round activities may comprise, based on the set of delay values, determining, step 312, a set of weight requirement values and a set of resource requirement values. The set of training round activities may comprise sending, step 1505, the set of weight requirement values and the set of resource requirement values to the edge server.

Each resource requirement value and each weight requirement value may correspond to a worker node from the set of neighboring worker nodes. Each resource requirement value may identify a resource minimum for communication between the worker node and the worker node from the set of neighboring worker nodes which corresponds to that resource requirement value. Each weight requirement value may identify a weight maximum for combining the machine learning model trained by the worker node with the corresponding machine learning model received from the neighboring worker node corresponding to that weight requirement value.

For each resource requirement value from the set of resource requirement values, the resource minimum identified by that resource requirement value may be a bandwidth minimum.

Updating, step 1507, the set of weight values based on the data for updating control values may comprise multiplying the data for updating control values by the set of weight requirement values.

The set of neighboring worker nodes may be comprised by a plurality of worker nodes. The edge server may also be a node comprised by the plurality of worker nodes.

The method may comprise, prior to performing the set of training round activities, receiving, step 1501, a set of weight values from the edge server. The set of neighboring worker nodes may be worker nodes identified as connected nodes in the set of weight values.

There is also provided a worker node comprising processing circuitry and a memory, the memory containing instructions executable by the processing circuitry whereby the worker node is operative to perform a set of acts. The set of acts may comprise performing, step 1502, a set of training round acts. The set of training round acts may comprise training, step 304, a local machine learning model using a local dataset. The set of training round acts may comprise exchanging, step 305, machine learning models with a set of neighboring worker nodes. The set of training round acts may comprise updating, step 307, the local machine learning model using a set of weight values and the machine learning models received from the set of neighboring worker nodes. The set of training round acts may comprise receiving, step 1506, from an edge server, data for updating control values. The set of training round acts may comprise updating, step 1507, the set of weight values based on the data for updating control values.

The worker node may be operative to repeat the set of training round acts one or more times, and to send, step 309, the local machine learning model to the edge server. The worker node may also be operative to send, step 309, the local machine learning model to the edge server after repeating the set of training round activities one or more times.

The data for updating control values may be a step size.

The worker node may comprise a memory storing the set of weight values and the local machine learning model.

Exchanging, step 305, machine learning models with the set of neighboring worker nodes may comprise, for each worker node from the set of neighboring worker nodes, sending, step 1503, the local machine learning model to that neighboring worker node. Exchanging, step 305, machine learning models with the set of neighboring worker nodes may also comprise receiving, step 1504, a corresponding machine learning model from that neighboring worker node.

Each worker node from the set of neighboring worker nodes may be identified as a connected worker node in the set of weight values.

The set of training round activities may comprise obtaining, step 306, a set of delay values. The set of delay values may comprise, for the worker node and each worker node from the set of neighboring worker nodes, a time spent by that worker node in machine learning model training and exchanging. The set of training round activities may also comprise, based on the set of delay values, determining, step 312, a set of weight requirement values and a set of resource requirement values. The set of training round activities may also comprise sending, step 1505, the set of weight requirement values and the set of resource requirement values to the edge server.

Each resource requirement value and each weight requirement value may correspond to a worker node from the set of neighboring worker nodes. Each resource requirement value may identifies a resource minimum for communication between the worker node and the worker node from the set of neighboring worker nodes which corresponds to that resource requirement value. Each weight requirement value may identify a weight maximum for combining the machine learning model trained by the worker node with the corresponding machine learning model received from the neighboring worker node corresponding to that weight requirement value.

For each resource requirement value from the set of resource requirement values, the resource minimum identified by that resource requirement value may be a bandwidth minimum.

Updating, step 1507, the set of weight values based on the data for updating control values may comprise multiplying the data for updating control values by the set of weight requirement values.

The set of neighboring worker nodes may be comprised by a plurality of worker nodes. The edge server may be a node comprised by the plurality of worker nodes.

The worker node may be operative to, prior to performing the set of training round activities, receive, step 1501, a set of weight values from the edge server. The set of neighboring worker nodes may be worker nodes identified as connected nodes in the set of weight values.

There is also provided a method for distributed machine learning. This method may comprise sending, step 302, to each of a plurality of nodes, a machine learning task. The machine learning task may comprise each of the plurality of nodes training a local machine learning model corresponding to that node using a set of training data corresponding to that node. The method may also comprise, after each of a plurality of training rounds, performing a set of network topology design activities, step 1402. The set of network topology design activities may comprise receiving, step 1407, one or more sets of resource requirement values and receiving, step 1406, one or more sets of weight requirement values. Each of the one or more sets of resource requirement values, and each of the one or more sets of weight requirement values may be received, steps 1406, 1407, from a corresponding node from the plurality of nodes. For each set of resource requirement values, and each set of weight requirement values, each resource requirement value from that set of resource requirement values and each weight requirement value from that set of weight requirement values may correspond to a different node from the plurality of nodes. For each set of resource requirement values, each resource requirement value from that set of resource requirement values may identify a resource minimum for communication between the node from which that set of resource requirement values was received and the different node corresponding to that resource requirement value. For each set of weight requirement values, each weight requirement value from that set of weight requirement values may identify a weight maximum for combining the local machine learning model corresponding to the node from which that set of weight requirement values was received with the local machine learning model corresponding to the different node corresponding to that weight requirement value. The set of network topology design activities may also comprise, based on the one or more sets of weight requirement values, generating, step 1403, data for updating control values used by the plurality of nodes to communicate and combine their corresponding local machine learning models. The set of network topology design activities may also comprise sending, step 1405, to the plurality of nodes, the data for updating control values used by the plurality of nodes to communicate and combine their corresponding local machine learning models. The method may also comprise, after the set of network topology design activities has been performed, step 1402, two or more times, receiving, step 310, a plurality of machine learning models. The plurality of machine learning models may comprise, for each node from the plurality of nodes, the local machine learning model corresponding to that node. The method may also comprise generating, step 311, an aggregated machine learning model based on the plurality of machine learning models.

There is also provided another method for distributed machine learning. This method may comprise sending, step 302, to each of a plurality of nodes, a machine learning task. The machine learning task may comprise each of the plurality of nodes training a local machine learning model corresponding to that node using a set of training data corresponding to that node. The method may also comprise, after each of a plurality of training rounds, performing, step 1402, a set of network topology design activities. The set of network topology design activities may comprises determining a step size. The step size may be determined by performing acts comprising determining a candidate step size based on, for each of the plurality of nodes, time taken by that node during a directly preceding training round to calculate the local machine learning model corresponding to that node and communicate the local machine learning model corresponding to that node to each of a set of neighboring nodes in the plurality of nodes. The step size may be determined by performing acts which also comprise validating, step 1404, periodic connectivity of a network generated by, for each of the plurality of nodes, that node using the candidate step size to update a set of weight values used by that node to combine the local machine learning model corresponding to that node with local machine learning models corresponding to other nodes from the plurality of nodes. The set of network topology design activities may also comprise, for each of the plurality of nodes, sending the determined step size to that node for use by that node in updating control values. The control values may be control values for communicating the local machine learning model corresponding to that node to other nodes from the plurality of nodes. The control values may also be control values for combining the local machine learning model corresponding to that node with local machine learning models corresponding to other nodes from the plurality of nodes. The method may comprise after the set of network topology design activities has been performed, step 1402, two or more times, receiving, step 310, a plurality of machine learning models. The plurality of machine learning models may comprise, for each node from the plurality of nodes, the local machine learning model corresponding to that node. The method may also comprise generating, step 311, an aggregated machine learning model based on the plurality of machine learning models.

There is also provided another method for distributed machine learning, the method performed by a worker node comprising a memory storing a set of weight values and a local machine learning model. This method may comprise performing a set of training round acts, step 1502. The set of training round acts may comprise training, step 304, the local machine learning model using a local dataset. The set of training round acts may comprise exchanging, step 305, machine learning models with a set of neighboring nodes. Each node from the set of neighboring nodes may be identified as a connected node in the set of weight values. Exchanging, step 305, machine learning models with the set of neighboring nodes may comprise, for each node from the set of neighboring nodes, sending, step 1503, the local machine learning model to that neighboring node. Exchanging, step 305, machine learning models with the set of neighboring nodes may also comprise receiving, step 1504, a corresponding machine learning model from that neighboring node. The set of training round acts may also comprise updating, step 307, the local machine learning model using the set of weight values and the machine learning models received from the set of neighboring nodes. The set of training round acts may also comprise obtaining, step 306, a set of delay values. The set of delay values may comprise, for the worker node and each node from the set of neighboring nodes, a time spent by that node in machine learning model training and exchanging. The set of training round acts may comprise, based on the set of delay values, determining, step 312, a set of weight requirement values and a set of resource requirement values. Each resource requirement value and each weight requirement value may correspond to a node from the set of neighboring nodes. Each resource requirement value may identify a resource minimum for communication between the worker node and the node from the set of neighboring nodes which corresponds to that resource requirement value. Each weight requirement value may identify a weight maximum for combining the machine learning model trained by the worker node with the corresponding machine learning model received from the neighboring node corresponding to that weight requirement value. The set of training round acts may also comprise sending, step 1505, the set of weight requirement values and the set of resource requirement values to a server. The set of training round acts may also comprise receiving, step 1506, from the server, control value update data. The set of training round activities may also comprise updating, step 1507, the set of weight values based on the control value update data. The method may also comprise repeating the set of training round acts one or more times. The method may also comprise, after repeating the set of training round activities one or more times, sending, step 309, the local machine learning model to the server.

There is also provided another method for distributed machine learning, the method performed by a worker node comprising a memory storing a set of weight values and a local machine learning model. The method may comprise performing, step 1502, a set of training round acts. The set of training round acts may comprise training, step 304, the local machine learning model using a local dataset. The set of training round acts may also comprise exchanging, step 305, machine learning models with a set of neighboring nodes. Each node from the set of neighboring nodes may be identified as a connected node in the set of weight values. Exchanging, step 305, machine learning models with the set of neighboring nodes may comprise, for each node from the set of neighboring nodes, sending, step 1503 the local machine learning model to that neighboring node and receiving, step 1504, a corresponding machine learning model from that neighboring node. The set of training round acts may comprise updating, step 307, the local machine learning model using the set of weight values and the machine learning models received from the set of neighboring nodes. The set of training round activities may comprise receiving, step 1506, control value update data from a server. The control value update data may comprise a step size. The set of training round acts may comprise updating, step 1507, the set of weight values based on multiplying the step size by a set of weight requirement values. Each weight requirement value may correspond to a neighboring node from the set of neighboring nodes. Each weight requirement value may also identify a weight maximum for combining the machine learning model trained by the worker node with the corresponding machine learning model received from the neighboring node corresponding to that weight requirement value. The method may also comprise repeating the set of training round activities one or more times. The method may also comprise, after repeating the set of training round activities one or more times, sending, step 309, the local machine learning model to the server.

There is also provided another method for distributed machine learning. This method may comprise sending, step 302, from a server to each of a plurality of nodes, a machine learning task. This method may also comprise sending, step 1401, from the server to each of the plurality of nodes, a set of weight values corresponding to that node. The machine learning task may comprise each of the plurality of nodes training a local machine learning model corresponding to that node using a set of training data corresponding to that node. The method may comprise each of the nodes from the plurality of nodes performing, step 1502, a set of training round acts. The set of training round acts may comprise training, step 304, the local machine learning model corresponding to that node using the set of training data received by that node from the server. The set of training round acts may also comprise exchanging, step 305, machine learning models with a set of neighboring nodes. Each node from the set of neighboring nodes may be identified as a connected node in the set of weight values received by that node from the server. Exchanging, step 305, machine learning models with the set of neighboring nodes may comprise, for each node from the set of neighboring nodes, sending, step 1503, the local machine learning model corresponding to that node to that neighboring node and receiving, step 1504, a corresponding machine learning model from that neighboring node. The set of training round acts may comprise updating, step 307, the local machine learning model corresponding to that node using the set of weight values and the machine learning models received from the set of neighboring nodes. The set of training round acts may comprise obtaining, step 306, a set of delay values. The set of delay values may comprise, for that node and each node from the set of neighboring nodes, a time spent in machine learning model training and exchanging. The set of training round acts may comprise, based on the set of delay values, determining, step 312, a set of weight requirement values and a set of resource requirement values. Each resource requirement value and each weight requirement value may correspond to a node from the set of neighboring nodes. Each resource requirement value may identify a resource minimum for communication between that node and the node from the set of neighboring nodes which corresponds to that resource requirement value. Each weight requirement value may identify a weight maximum for combining the machine learning model trained by that node with the corresponding machine learning model received from the neighboring node corresponding to that weight requirement value. The set of training round acts may comprise sending, step 1505, the set of weight requirement values and the set of resource requirement values to the server. The method may also comprise the server performing, step 1402, a set of network topology design activities. The set of network topology design acts may comprise receiving, step 1407, the sets of resource requirement values and receiving, step 1406, the sets of weight requirement values from the plurality of nodes. The set of network topology design acts may also comprise, based on the sets of resource requirement values and the sets of weight requirement values received from the plurality of nodes, generating, step 1403, control value update data. The set of network topology design acts may comprise sending, step 1405, the control value update data to each of the plurality of nodes. The set of training round acts may comprise each node from the plurality of nodes receiving, step 1506, the control value update data from the server. The set of training round acts may comprise updating, step 1507, the set of weight values corresponding to that node using the control value update data. The method may also comprise each node from the plurality of nodes repeating the set of training round acts one or more times. The method may also comprise the server repeating the set of network topology design acts one or more times. The method may also comprise each of the plurality of nodes sending, step 309, the machine learning model corresponding to that node to the server. The method may also comprise the server generating, step 311, an aggregated machine learning model based on the machine learning models sent by the plurality of nodes.

There is also provided another method for distributed machine learning. This method may comprise sending, step 302, from a server to each of a plurality of nodes, a machine learning task. The method may also comprise the server sending, step 1401, each node from the plurality of nodes and a set of weight values corresponding to that node. The machine learning task may comprise each of the plurality of nodes training a local machine learning model corresponding to that node using a set of training data corresponding to that node. The method may comprise each of the plurality of nodes performing, step 1502, a set of training round acts. The set of training round acts may comprise training, step 304, the local machine learning model corresponding to that node using the set of training data received by that node from the server. The set of training round acts may also comprise exchanging, step 305, machine learning models with a set of neighboring nodes. Each node from the set of neighboring nodes may be identified as a connected node in the set of weight values received by that node from the server. Exchanging, step 305, machine learning models with the set of neighboring nodes may comprise, for each node from the set of neighboring nodes, sending, step 1503, the local machine learning model corresponding to that node to that neighboring node and receiving, step 1504, a corresponding machine learning model from that neighboring node. The set of training round acts may comprise updating, step 307, the local machine learning model corresponding to that node using the set of weight values and the machine learning models received from the set of neighboring nodes. The method may comprise the server performing, step 1402, a set of network topology design acts. The set of network topology design acts may comprise determining a step size. Determining the step size may comprise determining a candidate step size based on, for each of the plurality of nodes, time taken by that node during a directly preceding performance of the set of machine learning acts to calculate the local machine learning model corresponding to that node and communicate the local machine learning model corresponding to that node to each of a set of neighboring nodes in the plurality of nodes. Determining the step size may also comprise validating periodic connectivity, step 1404, of a network generated by, for each of the plurality of nodes, that node using the candidate step size to update the corresponding set of weight values. The network topology design activities may also comprise sending the step size to each node from the plurality of nodes. The set of training round acts may comprise each node from the plurality of nodes receiving the step size from the server. The set of training round acts may also comprise each node from the plurality of nodes updating, step 1507, the set of weight values corresponding to that node based on multiplying the step size by a set of weight requirement values. Each weight requirement value may correspond to a neighboring node from the set of neighboring nodes. Each weight requirement value may identify a weight maximum for combining the machine learning model trained by the worker node with the corresponding machine learning model received from the neighboring node corresponding to that weight requirement value. The method may comprise each node from the plurality of nodes repeating the set of training round acts one or more times. The method may also comprise the server repeating the set of network topology design acts one or more times. The method may also comprise each of the plurality of nodes sending, step 309, the machine learning model corresponding to that node to the server. The method may also comprise the server generating, step 311, an aggregated machine learning model based on the machine learning models sent by the plurality of nodes.

As alluded to previously, tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray). The computer program instructions may also be loaded onto or otherwise downloaded to a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

Further, in at least some additional or alternative implementations, the functions/acts described in the blocks may occur out of the order shown in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated and blocks from different flowcharts may be combined, rearranged, and/or reconfigured into additional flowcharts in any combination or subcombination. Moreover, although some of the diagrams include arrows on communication paths to show a primary direction of communication, it is to be understood that communication may occur in the opposite direction relative to the depicted arrows.

Reference to an element in the singular is not intended to mean “one and only one” unless explicitly so stated, but rather “one or more” or “at least one”. Similarly, any statement that a first item is “based on” one or more other items should be understood to mean that the first item is determined at least in part by the other items it is identified as being “based on.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

1. A method for distributed machine learning performed by an edge server, the method comprising:
distributing, to each of a plurality of worker nodes, a machine learning task; and
after each of a plurality of training rounds, performing a set of network topology design activities, wherein the set of network topology design activities comprises:
generating data for updating control values; and
sending the data for updating control values to the plurality of worker nodes.

2. The method of claim 1, wherein the data for updating control values is a step size.

3. The method of claim 1 wherein the machine learning task comprises each of the plurality of worker nodes training a local machine learning model corresponding to that worker node using a set of training data corresponding to that worker node.

4. The method of claim 3, wherein the set of network topology design activities comprises receiving one or more sets of weight requirement values, wherein:
each of the one or more sets of weight requirement values is received from a corresponding worker node from the plurality of worker nodes;
for each set of weight requirement values, each weight requirement value from that set of weight requirement values corresponds to a different worker node from the plurality of worker nodes; and
for each set of weight requirement values, each weight requirement value from that set of weight requirement values identifies a weight maximum which the worker node from which that set of weight requirement values was received could have used on a preceding training round to combine the local machine learning model corresponding to the worker node from which that set of weight requirement values was received with the local machine learning model corresponding to the different worker node corresponding to that weight requirement value.

5. The method of claim 4, wherein:
the data for updating control values is data for updating parameters used by the plurality of worker nodes to communicate and combine their corresponding local machine learning models; and
generating data for updating control values is performed based on the one or more sets of weight requirement values.

6. The method of claim 3 wherein:
the method comprises:
receiving a plurality of machine learning models; and
generating an aggregated machine learning model based on the plurality of. machine learning models;
and
the plurality of machine learning models comprises, for each worker node from the plurality of worker nodes, a local machine learning model corresponding to that worker node.

7. The method of claim 6, wherein receiving the plurality of machine learning models and generating the aggregated machine learning model are both performed after the set of network design topology activities has been performed two or more times.

8. The method of claim 6 wherein:
the method comprises, on each training round from the plurality of training rounds:
training a local machine learning model corresponding to the edge server using a set of training data corresponding to the edge server;
exchanging machine learning models with a set of neighboring worker nodes for the edge server;
updating the local machine learning model using a set of weight values and the machine learning models received from the set of neighboring worker nodes for the edge server; and
updating the set of weight values based on the data for updating control values;
and
the aggregated machine learning model is generated based on the received plurality of machine learning models and the local machine learning model corresponding to the edge server.

9. (canceled)

10. (canceled)

11. The method of claim 1 wherein the set of network topology design activities comprises receiving one or more sets of resource requirement values, wherein:
each of the one or more sets of resource requirement values is received from a corresponding worker node from the plurality of worker nodes;
for each set of resource requirement values, each resource requirement value from that set of resource requirement values corresponds to a different worker node from the plurality of worker nodes; and
for each set of resource requirement values, each resource requirement value from that set of resource requirement values identifies a resource minimum for communication between the worker node from which that set of resource requirement values was received and the different worker node corresponding to that resource requirement value.

12. The method of claim 11, wherein, for each set of resource requirement values, for each resource requirement value from that set of resource requirement values, the resource minimum identified by that resource requirement value is a bandwidth minimum.

13. An edge server comprising processing circuitry and a memory, the memory containing instructions executable by the processing circuitry whereby the edge server is operative to:
distribute, to each of a plurality of worker nodes, a machine learning task; and
after each of a plurality of training rounds, perform a set of network topology design activities, wherein the set of network topology design activities comprises:
generate data for updating control values; and
send the data for updating control values to the plurality of worker nodes.

14. The edge server of claim 13, wherein the data for updating control values is a step size)

15. The edge server of claim 13 wherein the machine learning task comprises each of the plurality of worker nodes training a local machine learning model corresponding to that worker node using a set of training data corresponding to that worker node; wherein the set of network topology design activities comprises receiving one or more sets of weight requirement values, wherein:
each of the one or more sets of weight requirement values is received from a corresponding worker node from the plurality of worker nodes;
for each set of weight requirement values, each weight requirement value from that set of weight requirement values corresponds to a different worker node from the plurality of worker nodes; and
for each set of weight requirement values, each weight requirement value from that set of weight requirement values identifies a weight maximum which the worker node from which that set of weight requirement values was received could have used on a preceding training round to combine the local machine learning model corresponding to the worker node from which that set of weight requirement values was received with the local machine learning model corresponding to the different worker node corresponding to that weight requirement value; and
wherein:
the data for updating control values is data for updating parameters used by the plurality of worker nodes to communicate and combine their corresponding local machine learning models; and
generating data for updating control values is performed based on the one or more sets of weight requirement values.

16. (canceled)

17. (canceled)

18. (canceled)

19. (canceled)

20. (canceled)

21. (canceled)

22. (canceled)

23. (canceled)

24. (canceled)

25. A method for distributed machine learning performed by a worker node, the method comprising performing a set of training round acts comprising:
training a local machine learning model using a local dataset;
exchanging machine learning models with a set of neighboring worker nodes;
updating the local machine learning model using a set of weight values and the machine learning models from the set of neighboring worker nodes;
receiving, from an edge server, data for updating control values; and
updating the set of weight values based on the data for updating control values.

26. The method of claim 25, wherein:
the method comprises:
repeating the set of training round acts one or more times; and
sending the local machine learning model to the edge server;
and
sending the local machine learning model to the server is performed after repeating the set of training round acts one or more times.

27. The method of claim 25 wherein the data for updating control values is a step size.

28. (canceled)

29. The method of claim 25 wherein exchanging machine learning models with the set of neighboring worker nodes comprises, for each worker node from the set of neighboring worker nodes, sending the local machine learning model to that neighboring worker node and receiving a corresponding machine learning model from that neighboring worker node.

30. The method of claim 25 wherein each worker node from the set of neighboring worker nodes is identified as a connected worker node in the set of weight values.

31. The method of claim 25 wherein the set of training round activities comprises:
obtaining a set of delay values, wherein the set of delay values comprises, for the worker node and each worker node from the set of neighboring worker nodes, a time spent by that worker node in machine learning model training and exchanging;
based on the set of delay values, determining a set of weight requirement values and a set of resource requirement values; and
sending the set of weight requirement values and the set of resource requirement values to the edge server.

32-35. (canceled)

36. The method of claim 25 wherein:
the method comprises, prior to performing the set of training round activities, receiving a set of weight values from the edge server; and
the set of neighboring worker nodes are worker nodes identified as connected nodes in the set of weight values.

37-48. (canceled)
